(19) United States
(12) Patent Application Publication
(10) Pub. No.: US 2015/0170104 A1
(43) Pub. Date: Jun. 18, 2015

(54) TIME AND ATTENDANCE MANAGEMENT DEVICE, DATA PROCESSING METHOD THEREOF, AND PROGRAM

(71) Applicant: NEC Corporation, Minato-ku, Tokyo (JP)

(72) Inventors: Takao Yamada, Tokyo (JP); Saki Ito, Tokyo (JP)

(21) Appl. No.: 14/415,395

(22) PCT Filed: Jul. 19, 2013
(86) PCT No.: PCT/JP2013/069646

§ 371 Date: Jan. 16, 2015

(30) Foreign Application Priority Data
Jul. 24, 2012 (JP) 2012-164126

(51) Int. Cl. G06Q 10/10

(52) U.S. Cl. CPC G06Q 10/1091

(57) ABSTRACT

A time and attendance management device (100) includes: a control unit (102) that starts an application which uses an imaging function on a mobile terminal (10) by allowing the mobile terminal (10) having the imaging function to communicate wirelessly with a relay device (80) provided in a place where the user attends and leaves; an imaging unit (104) that images the face of the user using the imaging function by way of the application started by the control unit (102); an extraction unit (106) that acquires face image data of the user recognized from the captured image and extracts feature point data from the face image data of the user; and a recording unit (110) that records clock-in or clock-out information of the user based on the feature point data, as time and attendance information, in a time and attendance information storage unit (112) together with the current time.

### TECHNICAL FIELD

The present invention relates to a time and attendance management device, a data processing method thereof, and a program, and in particular, to a time and attendance management device using a user mobile terminal, a data processing method thereof, and a program.

### BACKGROUND ART

An example of a time recorder using a biometric authentication machine represented by fingerprint authentication, face authentication, voice authentication, or the like is disclosed in Patent Document 1. When the result of matching based on biometric authentication indicates a no-match, the biometrics time recorder disclosed in Patent Document 1 captures a user image with an imaging apparatus, and records the attendance time and the leaving time together with the image. Accordingly, it is possible to prevent an improper act from occurring on the grounds of authentication failure even though the authentication has been neglected deliberately.

### RELATED DOCUMENT

### Patent Document

[Patent Document 1] Japanese Unexamined Patent Publication No. 2005-182720

### DISCLOSURE OF THE INVENTION

### Problems to be Solved by the Invention

In the technique disclosed in Patent Document described above, an expensive biometric authentication machine is used. Accordingly, in franchised restaurants of the food service industry and convenience stores, and the like, there has been a problem in that expensive authentication machines must be introduced to the stores, leading to an increased cost.

The present invention has been made in view of the above situation, and it is an object of the present invention to provide a time and attendance management device for preventing an improper act while suppressing the cost, a data processing method thereof, and a program.

### Means for Solving the Problems

A time and attendance management device of the present invention includes: a control unit that starts an application which uses an imaging function on a user mobile terminal by allowing the user mobile terminal having the imaging function to communicate wirelessly with a relay device provided in a place where a user attends and leaves; an imaging unit that images a face of the user using the imaging function by way of the application started by the control unit; an extraction unit that acquires face image data of the user recognized from a captured image and extracts feature point data from the face image data of the user; and a recording unit that records clock-in or clock-out information of the user based on the feature point data, as time and attendance information, in a time and attendance information storage device together with a current time.

A data processing method of a time and attendance management device of the present invention includes: starting, by the time and attendance management device, an application which uses an imaging function on a user mobile terminal by allowing the user mobile terminal having the imaging function to communicate wirelessly with a relay device provided in a place where a user attends and leaves; imaging, by the time and attendance management device, a face of the user using the imaging function by way of the started application; acquiring, by the time and attendance management device, face image data of the user recognized from a captured image; extracting, by the time and attendance management device, feature point data from the face image data of the user; and recording, by the time and attendance management device, clock-in or clock-out information of the user based on the feature point data, as time and attendance information, in a time and attendance information storage device together with a current time.

A computer program of the present invention is a program causing a computer for realizing a time and attendance management device to execute: a procedure for starting an application which uses an imaging function on a user mobile terminal by allowing the user mobile terminal having the imaging function to communicate wirelessly with a relay device provided in a place where a user attends and leaves; a procedure for imaging a face of the user using the imaging function by way of the started application; a procedure for acquiring face image data of the user recognized from a captured image; a procedure for extracting feature point data from the face image data of the user; and a procedure for recording clock-in or clock-out information of the user based on the feature point data, as time and attendance information, in a time and attendance information storage device together with a current time when a clock-in or clock-out of the user is received.

In addition, any combination of the above-described components and those obtained by converting the expression of the present invention into a method, an apparatus, a system, a recording medium, a computer program, and the like are also effective as aspects of the present invention.

In addition, various components of the present invention do not necessarily need to be separate entities. For example, a plurality of components may be formed as one member, one component may be formed by a plurality of members, a certain component may be a part of another component, or a part of a certain component and a part of another component may overlap each other.

In addition, although a plurality of procedures are described in order in the data processing method and the computer program of the present invention, the description order does not limit the order in which the plurality of procedures are executed. Therefore, when executing the data processing method and the computer program of the present invention, the order of the plurality of procedures may be changed in a range that does not interfere with the contents.

In addition, the plurality of procedures of the data processing method and the computer program of the present invention are not limited to being executed at different timings. Therefore, for example, another procedure may occur during the execution of a certain procedure, or some or all of the execution timing of a certain procedure and the execution timing of another procedure may overlap each other.

### Effects of the Invention

According to the present invention, it is possible to provide a time and attendance management system capable of preventing an improper act while suppressing the cost.

### BRIEF DESCRIPTION OF THE DRAWINGS

The above-described object and other objects, features, and advantages will become more apparent by preferred exemplary embodiments described below and the following accompanying diagrams.

FIG. 1 is a block diagram showing an overview of the configuration of a time and attendance management system according to an exemplary embodiment of the present invention.

FIG. 2 is a functional block diagram showing the configuration of the time and attendance management device according to the exemplary embodiment of the present invention.

FIG. 3 is a block diagram showing the hardware configuration of a mobile terminal of the time and attendance management system according to the exemplary embodiment of the present invention.

FIG. 4 is a block diagram showing the hardware configuration of a management server of the time and attendance management system according to the exemplary embodiment of the present invention.

FIG. 5 is a functional block diagram showing an example of the configuration of each device of the time and attendance management system according to the exemplary embodiment of the present invention.

FIG. 6 is a functional block diagram showing the main part configuration of the mobile terminal of the time and attendance management system according to the exemplary embodiment of the present invention.

FIG. 7 is a flowchart showing an example of the operation of the time and attendance management device according to the exemplary embodiment of the present invention.

FIG. 8 is a flowchart showing an example of the operation of each device of the time and attendance management system according to the exemplary embodiment of the present invention.

FIG. 9 is a diagram showing an example of the screen configuration of the time and attendance management system according to the exemplary embodiment of the present invention.

FIG. 10 is a diagram showing an example of the screen flow of the time and attendance management system according to the exemplary embodiment of the present invention.

FIG. 11 is a diagram showing a login screen of the time and attendance management system according to the exemplary embodiment of the present invention.

FIG. 12 is a diagram showing a main screen of the time and attendance management system according to the exemplary embodiment of the present invention.

FIG. 13 is a diagram showing an example of the initial setting screen of the time and attendance management system according to the exemplary embodiment of the present invention.

FIG. 14 is a diagram showing an example of the registration confirmation dialog of the time and attendance management system according to the exemplary embodiment of the present invention.

FIG. 15 is a diagram showing an example of the face authentication screen of the time and attendance management system according to the exemplary embodiment of the present invention.

FIG. 16 is a diagram showing an example of the structure of a user master of the time and attendance management system according to the exemplary embodiment of the present invention.

FIG. 17 is a diagram showing an example of the structure of a store master of the time and attendance management system according to the exemplary embodiment of the present invention.

FIG. 18 is a functional block diagram showing the configuration of the time and attendance management device according to the exemplary embodiment of the present invention.

FIG. 19 is a flowchart showing an example of the operation of each device of the time and attendance management system according to the exemplary embodiment of the present invention.

FIG. 20 is a functional block diagram showing the configuration of the time and attendance management device according to the exemplary embodiment of the present invention.

FIG. 21 is a flowchart showing an example of the operation of each device of the time and attendance management system according to the exemplary embodiment of the present invention.

FIG. 22 is a functional block diagram showing the configuration of the time and attendance management device according to the exemplary embodiment of the present invention.

FIG. 23 is a flowchart showing an example of the operation of each device of the time and attendance management system according to the exemplary embodiment of the present invention.

FIG. 24 is a flowchart showing an example of the operation of each device of the time and attendance management system according to the exemplary embodiment of the present invention.

### DESCRIPTION OF EXEMPLARY EMBODIMENTS

Hereinafter, exemplary embodiments of the present invention will be described with reference to the diagrams. In addition, the same components are denoted by the same reference numerals in all diagrams, and explanation thereof will not be repeated. In addition, in the following diagrams, the configuration of units not relevant to the essence of the present invention will not be repeated and not shown.

### First Exemplary Embodiment

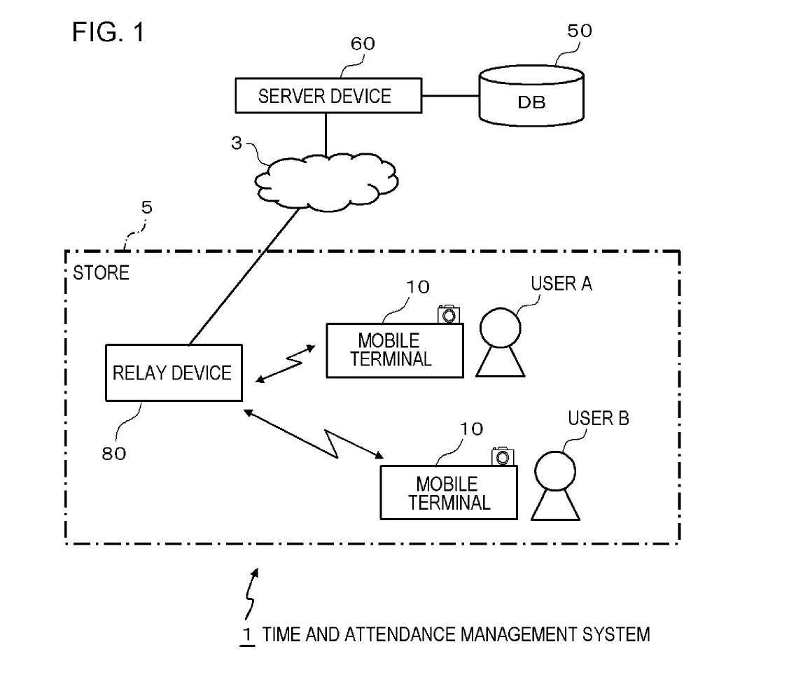

FIG. 1 is a block diagram showing an overview of the configuration of a time and attendance management system 1 according to an exemplary embodiment of the present invention.

The time and attendance management system 1 of the present exemplary embodiment includes a mobile terminal 10 that a user uses, a relay device 80 provided in a store 5, a server device 60 that can communicate with the mobile terminal 10 and the relay device 80 through a network 3, and a database 50 (indicated by “DB” in the drawings) connected to the server device 60.

In the time and attendance management system 1 according to the exemplary embodiment of the present invention, a user who works part-time in the store 5 captures his or her own face using the mobile terminal 10 used by the user and transmits the result to the server device 60 through the relay device 80 provided in the store 5 as time and attendance data for authentication, thereby being able to perform a clock-in or clock-out operation when the user attends work or leaves work.

Although the user mobile terminal (mobile terminal 10) used by the user is described as an example in the present exemplary embodiment, the present invention is not limited thereto. For example, it is possible to use not only a smart phone but also mobile type wireless communication terminals, such as a mobile phone, a personal digital assistant (PDA), a tablet terminal, a game machine, and other electronic apparatuses. In addition, the mobile terminal of the present invention may be a mobile terminal placed in a store or the like or may be a terminal, which can be used in common by users working in the place, in addition to the mobile terminal carried by the user.

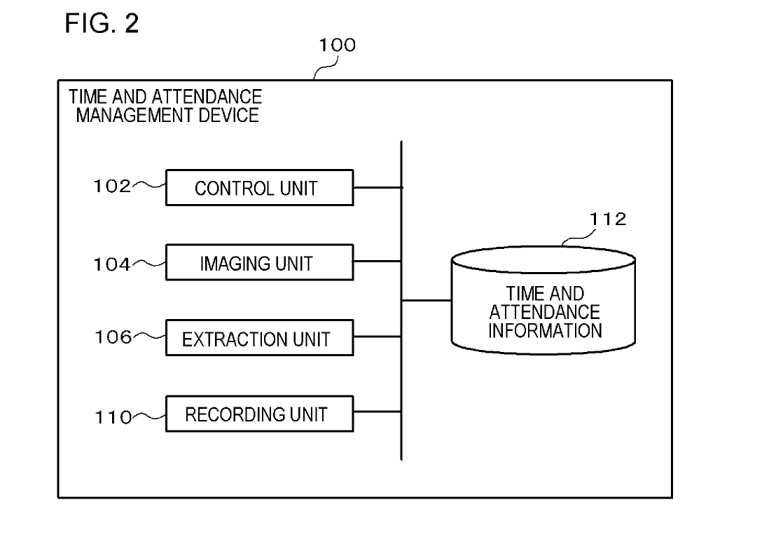

FIG. 2 is a functional block diagram showing the configuration of a time and attendance management device 100 according to the exemplary embodiment of the present invention.

The time and attendance management device 100 according to the exemplary embodiment of the present invention includes: a control unit 102 that starts an application which uses an imaging function on the mobile terminal 10 by allowing a user mobile terminal (mobile terminal 10) having the imaging function to communicate wirelessly with the relay device 80 provided in a place where the user attends and leaves; an imaging unit 104 that images the face of the user using the imaging function by way of the application started by the control unit 102; an extraction unit 106 that acquires face image data of the user recognized from the captured image and extracts feature point data from the face image data of the user; and a recording unit 110 that records clock-in or clock-out information of the user based on the feature point data, as time and attendance information, in a time and attendance information storage device (time and attendance information storage unit 112; shown as “time and attendance information” in the drawings) together with a current time.

As will be described in detail for each component later, the time and attendance management device 100 according to the exemplary embodiment of the present invention may be realized by the mobile terminal 10, or the server device 60 that can communicate with the mobile terminal 10, or a combination thereof.

By installing an application program for realizing the time and attendance management device 100 according to the exemplary embodiment of the present invention in advance in the mobile terminal 10, the function of a computer program for realizing the time and attendance management device 100 of the present invention may be realized on the mobile terminal 10. Alternatively, by providing a web page on a web server (not shown) and making the user access the website using the mobile terminal 10, the function of the time and attendance management device 100 may be used in the mobile terminal 10.

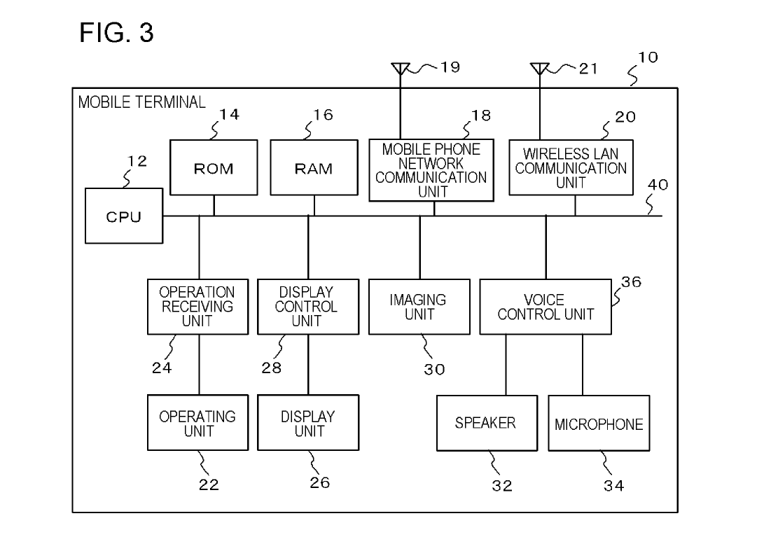

FIG. 3 is a block diagram showing the hardware configuration of the mobile terminal 10 of the time and attendance management system 1 according to the exemplary embodiment of the present invention. As shown in FIG. 3, the mobile terminal 10 of the present exemplary embodiment includes a central processing unit (CPU) 12, a read only memory (ROM) 14, a random access memory (RAM) 16, a mobile phone network communication unit 18, a wireless local area network (LAN) communication unit 20, an operating unit 22, an operation receiving unit 24, a display unit 26, a display control unit 28, an imaging unit 30, a speaker 32, a microphone 34, and a voice control unit 36.

The CPU 12 is connected to each component of the mobile terminal 10 through a bus 40, and controls the entire mobile terminal 10 as well as each component. The ROM 14 stores a program or various application programs for operating the mobile terminal 10 and various kinds of setting data used when these programs operate, and stores user data including address data and various kinds of contents data. The RAM 16 has an area for temporarily storing data, such as a working area for operating a program.

Each component of the mobile terminal 10 is realized by an arbitrary combination of hardware and software of an arbitrary computer including the CPU 12, the RAM 16, a program for realizing at least a part of the components in FIG. 2 that is loaded into the RAM 16, the ROM 14 in which the program is stored, and an interface for network connection (the mobile phone network communication unit 18 or the wireless LAN communication unit 20 shown in FIG. 3). In addition, it will be understood by those skilled in the art that various modifications of the implementation method and the apparatus may be made. Each functional block diagram described below does not show the configuration of a hardware unit but shows a block of a logical functional unit.

In addition, the ROM 14 and the RAM 16 may be other devices having a function of storing an application program and setting data or temporary storage data for operating a program, user data, and the like, such as a flash memory or a disk drive.

The operating unit 22 includes an operation key, an operation button, a switch, a jog dial, a touch pad, a touch panel integrated with the display unit 26, and the like. The operation receiving unit 24 receives an operation of the operating unit 22 by the user, and notifies the CPU 12 of the operation. The display unit 26 includes a light emitting diode (LED) display, a liquid crystal display, an organic electroluminescence (EL) display, and the like. The display control unit 28 displays various screens on the display unit 26 in response to the instruction from the CPU 12. The voice control unit 36 performs voice output from the speaker 32 and voice input from the microphone 34 in response to the instruction from the CPU 12.

The mobile terminal 10 performs communication by being connected to a mobile communication network (not shown) through a base station (not shown), for example, in a 3rd generation (3G) mobile phone system using the mobile phone network communication unit 18 and a mobile phone network antenna 19. The mobile terminal 10 is connected from the mobile communication network to the network 3 (FIG. 1), such as the Internet, thereby being able to communicate with the server device 60 (FIG. 1). When performing the function of the time and attendance management device 100 of the present invention, connection with the server device 60 is assumed to be performed through the relay device 80 (FIG. 1) using the following wireless LAN communication instead of being performed through the mobile communication network. This is because it can be confirmed that the user is actually in the store 5 by performing the connection through the relay device 80 provided in the store 5.

The wireless LAN communication unit 20 performs wireless LAN communication with the relay device 80 (FIG. 1) through a wireless LAN antenna 21, for example, in a method conforming to the IEEE802.11 standard. In the present exemplary embodiment, the mobile terminal 10 may perform wireless LAN communication with the relay device 80 provided in the store 5 using the wireless LAN communication unit 20.

When the function of the wireless LAN communication unit 20 of the mobile terminal 10 is enabled, the wireless LAN communication unit 20 transmits a management frame conforming to the IEEE802.11 standard, for example, ‘Probe Request’ at predetermined periods or an arbitrary timing. The relay device 80 that has received this signal may establish wireless communication between the relay device 80 and the mobile terminal 10 by performing predetermined procedures, for example, authentication processing or the like between the relay device 80 and the mobile terminal 10. In the present exemplary embodiment, it is assumed that the function of the wireless LAN communication unit 20 of the mobile terminal 10 is always enabled when using the function of the time and attendance management device 100.

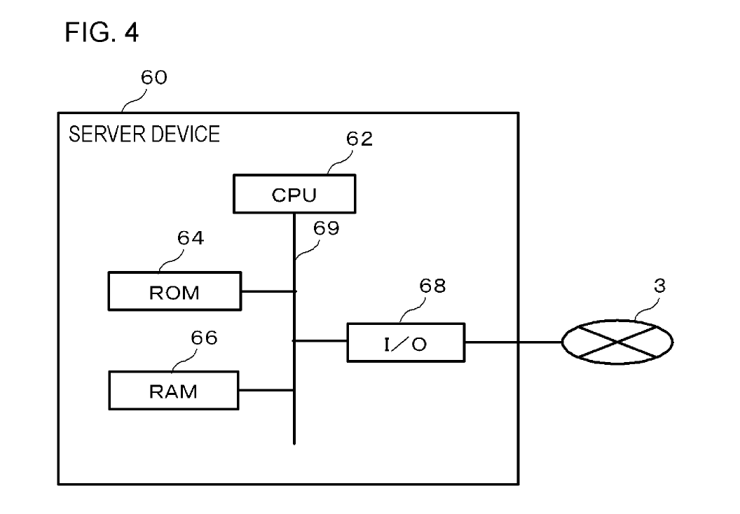

FIG. 4 is a block diagram showing the hardware configuration of the server device 60 of the time and attendance management system 1 according to the exemplary embodiment of the present invention.

The server device 60 of the present exemplary embodiment may be realized by a server computer or a personal computer connected to the database 50 (FIG. 1) or by a device corresponding to these. In addition, the server device 60 may be formed by a virtual server or the like.

Each component of the server device 60 of the time and attendance management system 1 of the present exemplary embodiment is realized by an arbitrary combination of hardware and software of an arbitrary computer including a CPU 62, a RAM 66, a program for realizing at least some of the components of the time and attendance management device 100 in FIG. 2 that is loaded into the RAM 66, a ROM 64 in which the program is stored, and an input/output (I/O) 68 including an interface for network connection. The CPU 62 is connected to each element of the server device 60 through a bus 69, and controls the entire server device 60 as well as each component. In addition, it will be understood by those skilled in the art that various modifications of the implementation method and the apparatus may be made. As described above, each functional block diagram described below does not show the configuration of a hardware unit but shows a block of a logical functional unit. In addition, the server device 60 may also be connected to an input and output device (not shown) through the I/O 68.

Although not shown, each component of the relay device 80 is realized by an arbitrary combination of hardware and software of an arbitrary computer including a CPU, a memory, a program loaded into the memory, a storage unit such as a hard disk in which the program is stored, and an interface for network connection. In addition, it will be understood by those skilled in the art that various modifications of the implementation method and the apparatus may be made. As described above, each functional block diagram described below does not show the configuration of a hardware unit but shows a block of a logical functional unit.

In the present exemplary embodiment, the relay device 80 is, for example, a router or a switch that performs relay between the mobile terminal 10 and the server device 60. As one of the functions for realizing the components of the time and attendance management device 100 of the present exemplary embodiment, the relay device 80 is provided between the mobile terminal 10 and the server device 60 so that the relay device 80 transmits its own identification information, for example, an IP address to the server device 60 as information for specifying the location at which the mobile terminal 10 is communicating.

As described above, each component of the time and attendance management device 100 of the present invention may be provided either in the mobile terminal 10 or in the server device 60 of the time and attendance management system 1, or may be combined in various combinations in a shared manner. Alternatively, in other exemplary embodiments, the relay device 80 may realize apart of the functions.

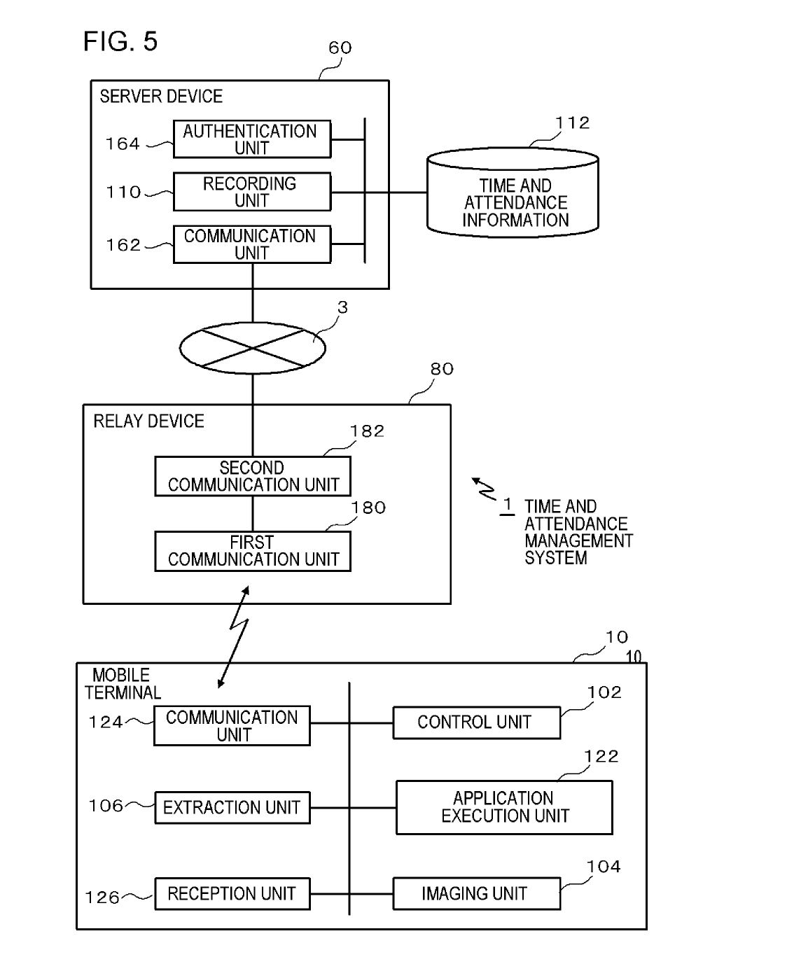

FIG. 5 shows an example of the configuration of each device of the time and attendance management system 1 of the present exemplary embodiment.

In the example shown in FIG. 5, the time and attendance management system 1 of the present exemplary embodiment includes: the mobile terminal 10 including the control unit 102, the imaging unit 104, the extraction unit 106, an application execution unit 122, a communication unit 124, and a reception unit 126; the relay device 80 including a first communication unit 180 and a second communication unit 182; and the server device 60 including the recording unit 110, a communication unit 162, and an authentication unit 164. In addition, the database 50 (FIG. 1) includes the time and attendance information storage unit 112.

In the mobile terminal 10, the communication unit 124 performs wireless LAN communication with the relay device 80 using the wireless LAN communication unit 20 of the mobile terminal 10 shown in FIG. 3. When the function of the wireless LAN communication unit 20 is enabled, the communication unit 124 transmits a management frame conforming to the IEEE802.11 standard, for example, ‘Probe Request’ periodically or at an arbitrary timing. Then, the communication unit 124 receives a response from the relay device 80 that has received the signal, for example, ‘Probe Response’, and establishes wireless communication with the relay device 80 after performing predetermined procedures. Then, the communication unit 124 is connected to the server device 60 on the network 3 through the relay device 80.

In the mobile terminal 10, the control unit 102 instructs the application execution unit 122 to start an application which uses an imaging function on the mobile terminal 10 when wireless communication between the communication unit 124 and the relay device 80 provided in a place where the user attends and leaves is established.

Alternatively, instead of the above-described configuration in which the mobile terminal 10 itself starts the application by determining the establishment of communication with the relay device 80, the relay device 80 and the server device 60 may determine the permission of the use of the application on the mobile terminal 10 and make the mobile terminal 10 execute the application. For example, when the management frame transmitted from the mobile terminal 10 is detected, the relay device 80 notifies the server device 60 of the identification information of the mobile terminal 10, so that it may be recognized that the target mobile terminal 10 is present in the wireless LAN communication area of the relay device 80 provided in the store 5. In addition, after the server device 60 authenticates the mobile terminal 10, the server device 60 may allow the mobile terminal 10 to start the application or may distribute an available application to the mobile terminal 10.

Thus, the control unit 102 can be realized by the mobile terminal 10, the combination of the mobile terminal 10 and the server device 60, or the combination of the mobile terminal 10, the relay device 80, and the server device 60. In the present exemplary embodiment, however, it is assumed that the relay device 80 only has a relay function between the mobile terminal 10 and the server device 60 without having a special configuration.

The imaging unit 104 images a face of the user by using an imaging function (imaging unit 30 of the mobile terminal 10 shown in FIG. 3) by way of the application started by the control unit 102. The captured image is displayed on the screen of the display unit 26 of the mobile terminal 10 shown in FIG. 3 as a camera view.

The extraction unit 106 acquires the face image data of the user recognized from the captured image, and extracts feature point data from the face image data of the user.

For example, the feature point data can be data (may be a vector quantity) obtained by extracting a plurality of feature points, which has at least the amount of information required to identify the user, from the face image data of the user recognized from the captured image and associating the relative position of the feature point in the face image region with the feature quantity of each feature point. That is, the feature point data is data having the amount of information (capacity) smaller than face image data.

The extracted feature point data is transmitted to the server device 60 through the relay device 80, and is used for user authentication processing. In the case of a configuration to transmit the feature point data to the server device 60, it is possible to reduce the communication capacity. Therefore, it is possible to suppress the load on the network. In addition, in the case of the configuration to transmit only the feature point data, personal information by which an individual can be identified, such as a face photo, is not handled. Therefore, it is possible to guarantee security.

Thus, although the extraction unit 106 is configured to be included in the mobile terminal 10 in the present exemplary embodiment, the invention is not limited thereto. For example, the server device 60 may include the extraction unit 106. In this case, face image data is transmitted to the server device 60 from the mobile terminal 10. In this case, since it is possible to suppress the processing load of the mobile terminal 10, this is effective when the processing capacity of the mobile terminal 10 is low and the like. In addition, it is preferable to perform processing for reducing the communication load as much as possible or ensuring security by performing compression processing or encryption processing when the data is transmitted.

The application execution unit 122 executes an application which uses the imaging function of the imaging unit 30 of the mobile terminal 10 shown in FIG. 3. The application is stored, for example, in the ROM 14 shown in FIG. 3, and is executed by the CPU 12 shown in FIG. 3.

The reception unit 126 receives a punching operation of the user through the application executed by the application execution unit 122. The user can perform a punching operation according to the screen displayed on the display unit 26 shown in FIG. 3 using the operating unit 22 of the mobile terminal 10 shown in FIG. 3. A specific operation method will be described later.

In the relay device 80, the first communication unit 180 performs wireless LAN communication with the mobile terminal 10. The second communication unit 182 communicates with the server device 60 through the network 3. A communication method between the relay device 80 and the server device 60 may be wireless communication or may be wired communication. The relay device 80 performs relay between the mobile terminal 10, which communicates with the first communication unit 180, and the server device 60, which communicates with the second communication unit 182. For example, the first communication unit 180 receives data transmitted from the mobile terminal 10 to the server device 60, and the second communication unit 182 forwards the received data to the server device 60. Alternatively, the second communication unit 182 receives data transmitted from the server device 60 to the mobile terminal 10, and the first communication unit 180 forwards the received data to the mobile terminal 10.

In the server device 60, the communication unit 162 communicates with the relay device 80 through the network 3. In the present exemplary embodiment, the server device 60 may communicate with the mobile terminal 10 through the relay device 80.

The time and attendance information storage unit 112 stores the time and attendance information of the user.

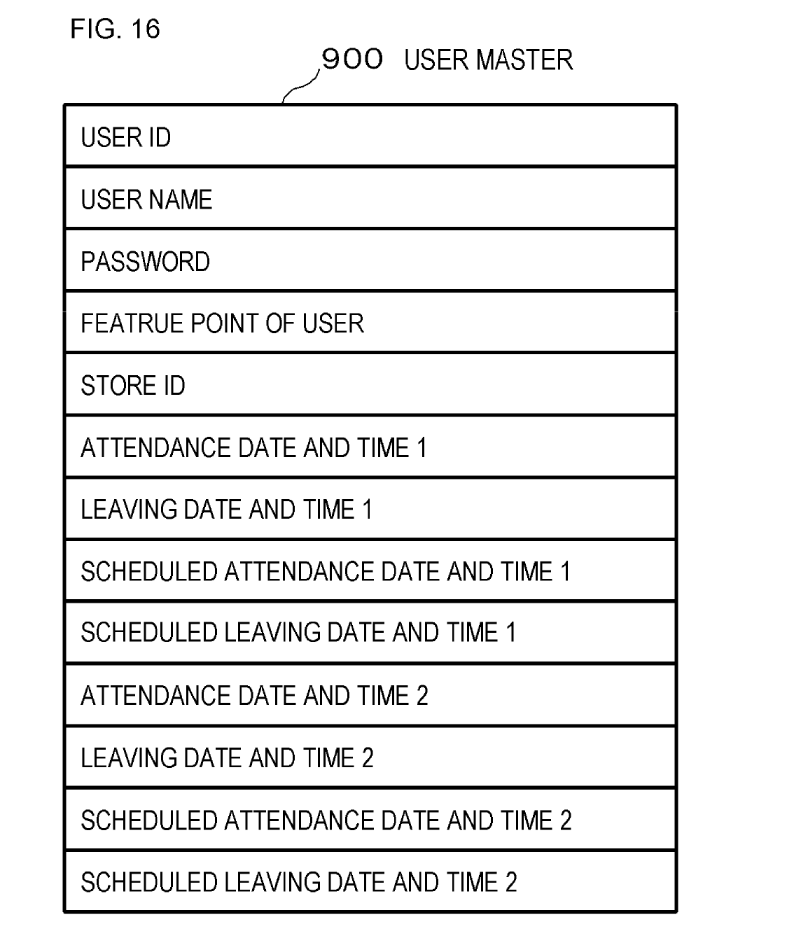

In the present exemplary embodiment, the time and attendance information storage unit 112 stores, for example, a user master 900 shown in FIG. 16 in the database 50 of the server device 60. The user master 900 stores, for each user ID, the records of a user name, a password, feature point data of the face image of the user, a store ID of the store in which the user works, scheduled attendance and leaving date and time for which the user is scheduled to work at this store, and the actual attendance and leaving date and time, for example. In the present exemplary embodiment, attending work multiple times a day in one store, for example, attending work twice a day in one store is assumed, and information of two attendances may be stored.

In addition, when a user works in a plurality of stores, the user master 900 may further store such information for each store.

In the configuration shown in FIG. 16, the feature point data received as clock-in or clock-out information is not recorded in the user master 900. However, in other exemplary embodiments, the received feature point data may be stored so as to be associated with the attendance and leaving date and time information. In the present exemplary embodiment, as will be described later, the server device 60 performs user identification based on the feature point data, and records the attendance and leaving date and time with respect to the authenticated user. However, in other exemplary embodiments, the feature point data or face image data received from the mobile terminal 10 may be temporarily recorded in the user master 900, and authentication processing for user identification may be performed later.

The recording unit 110 records the clock-in or clock-out information of the user based on the feature point data, as time and attendance information, in the time and attendance information storage unit 112 together with the current time. In the present exemplary embodiment, the attendance and leaving date and time is set to a time when the recording unit 110 of the server device 60 records the received clock-in or clock-out information (feature point data) of the user in the time and attendance information storage unit 112. However, various times, such as a time when the communication unit 162 of the server device 60 receives the clock-in or clock-out information (feature point data) or a time when the clock-in or clock-out information (feature point data) is transmitted from the mobile terminal 10 or the relay device 80, may be considered as the attendance and leaving date and time without being limited to the above.

The authentication unit 164 performs authentication processing regarding whether or not the feature point data of the face image of the user transmitted from the mobile terminal 10 matches the user based on the feature point data of the face image of the user registered in advance in the user master 900. When it is confirmed that the feature point data matches the user, the authentication unit 164 allows the recording unit 110 to record the attendance and leaving date and time in the user master 900. When an authentication result indicating that the feature point data does not match the user is obtained, the authentication unit 164 prohibits the recording unit 110 from recording the attendance and leaving date and time in the user master 900. In addition, the recording unit 110 may record the authentication result of the authentication unit 164 in the user master 900. In addition, when an authentication result indicating that the feature point data does not match the user is obtained from the authentication unit 164, the communication unit 162 may notify the mobile terminal 10 of the authentication error through the relay device 80 and may prompt the user to capture the face image again.

In addition, the authentication unit 164 does not necessarily need to perform authentication processing when receiving the clock-in or clock-out operation as described above, and may be performed at an arbitrary timing when necessary. When the authentication unit 164 performs authentication processing at an arbitrary timing, the recording unit 110 may store the result in the user master 900. Alternatively, for example, the communication unit 162 may transmit an e-mail or a message notifying the destination registered in advance of the authentication result, or may notify a person in charge of the store 5 of the authentication result by introducing the management system into the computer provided in the store 5 and transmitting the authentication result to the management system through the communication unit 162.

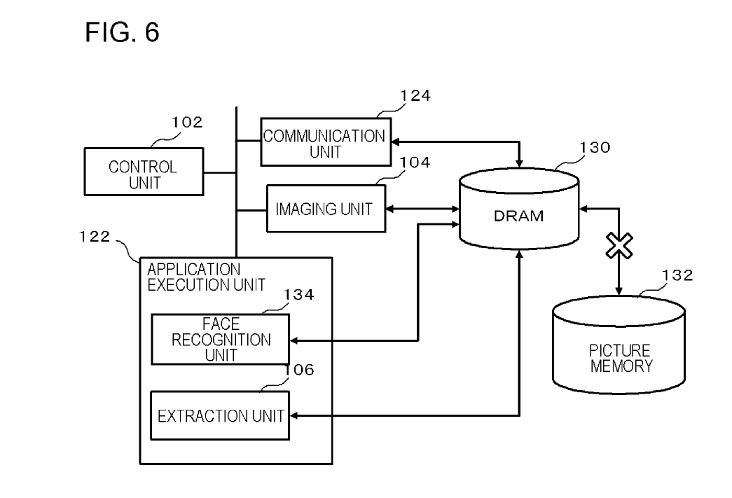

In addition, the mobile terminal 10 of the time and attendance management system 1 of the present exemplary embodiment further includes a dynamic random access memory (DRAM) 130, a picture memory 132, and a face recognition unit 134, as shown in FIG. 6.

The DRAM 130 is a volatile memory, and may be included in the RAM 16 of the mobile terminal 10 shown in FIG. 3. The picture memory 132 is included in the ROM 14 of the mobile terminal 10 shown in FIG. 3 or in a recording medium, such as a readable and writable secure digital (SD) memory card which is mounted in the mobile terminal 10.

The DRAM 130 temporarily stores the image data captured by the imaging unit 104. In a typical camera operation in the mobile terminal 10, the image data temporarily stored in the DRAM 130 is permanently stored by being moved from the DRAM 130 to the picture memory 132 after the storage is confirmed by the user.

In the present exemplary embodiment, however, the control unit 102 prohibits the image data captured by the imaging unit 104 from being moved from the DRAM 130 to the picture memory 132. Accordingly, a situation is prevented in which the face of the user is captured in advance outside the store 5 and another person impersonates the user and performs an improper act using the stored image data.

The face recognition unit 134 accesses the DRAM 130 to recognize the face and acquire the face image from the captured image data. The extraction unit 106 extracts feature points from the face image acquired by the face recognition unit 134, acquires feature point data, and stores the feature point data in the DRAM 130 temporarily. Alternatively, the extraction unit 106 may transfer the acquired feature point data to the communication unit 124 to be transmitted to the relay device 80. In addition, as described above, the server device 60 may include the face recognition unit 134.

In the time and attendance management system 1 of the present exemplary embodiment, the various units described above are realized as various functions when the CPU of the server device 60, the mobile terminal 10, or the relay device 80 performs various kinds of processing operations corresponding to a computer program.

A computer program of the present exemplary embodiment causes a computer for realizing the time and attendance management device 100 to execute: a procedure for starting an application which uses an imaging function on the mobile terminal 10 by allowing the mobile terminal 10 having the imaging function to communicate wirelessly with the relay device 80 provided in a place where the user attends and leaves; a procedure for imaging the face of the user using the imaging function by way of the started application; a procedure for acquiring face image data of the user recognized from the captured image; a procedure for extracting feature point data from the face image data of the user; and a procedure for recording clock-in or clock-out information of the user based on the feature point data, as time and attendance information, in a time and attendance information storage device (time and attendance information storage unit 112) together with a current time when the clock-in or clock-out operation of the user is received.

The computer program of the present exemplary embodiment described above may be recorded on a computer-readable recording medium. The recording medium is not particularly limited, and various forms of recording media may be used. In addition, a program may be loaded from the recording medium into the memory of the computer, or may be downloaded to the computer through a network and be loaded into the memory.

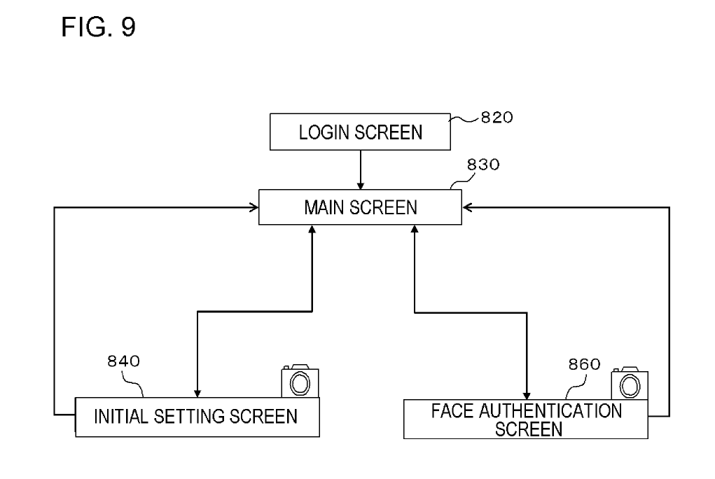

FIG. 9 is a diagram showing an example of the screen configuration of the mobile terminal 10 of the time and attendance management system 1 according to the exemplary embodiment of the present invention.

The screen configuration of the time and attendance management system 1 includes a login screen 820, a main screen 830, an initial setting screen 840, and a face authentication screen 860.

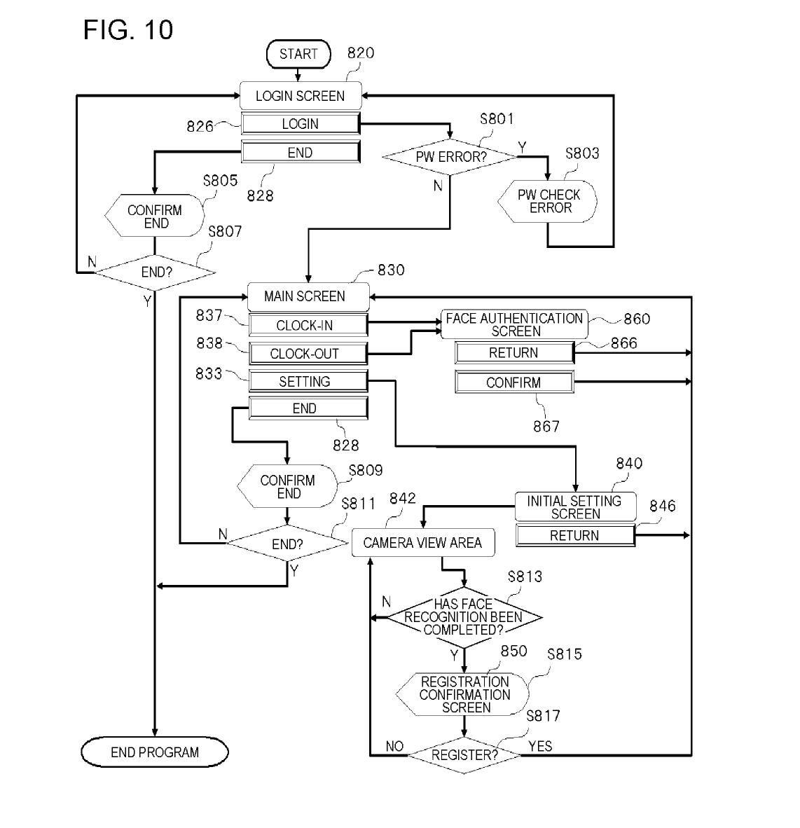

These screens are switched according to the flow shown in FIG. 10.

When the application of the time and attendance management system 1 of the present exemplary embodiment is started by the application execution unit 122 of the mobile terminal 10, the flow shown in FIG. 10 starts.

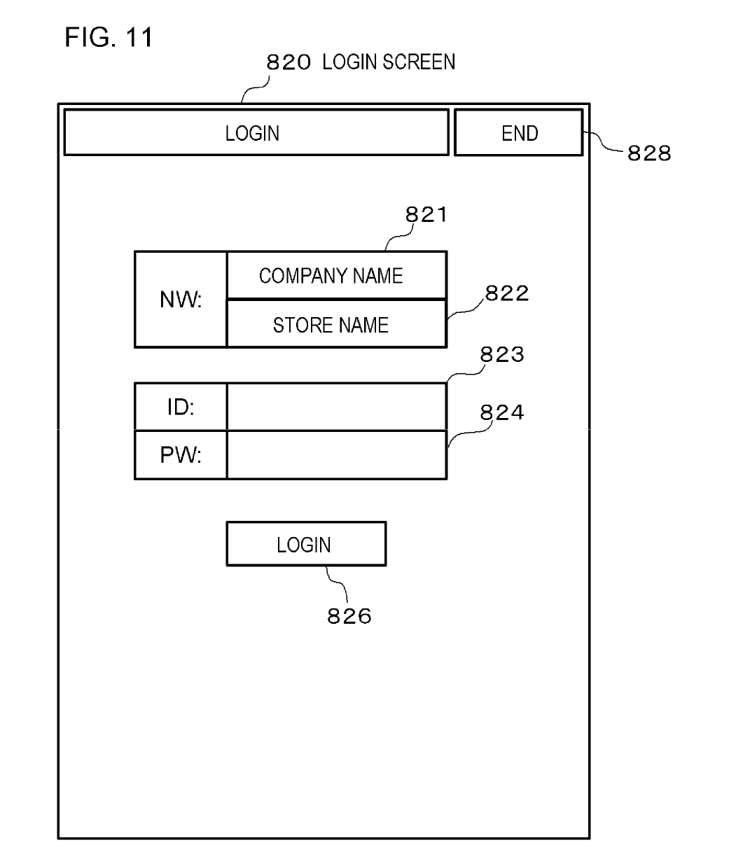

First, the login screen 820 is displayed. As shown in FIG. 11, the login screen 820 includes a company name display portion 821, a store name display portion 822, a user ID input column 823, a password input column 824, a login button 826, and an end button 828.

When the login screen 820 is displayed, a company name and a store name registered in advance for the user are displayed on the company name display portion 821 and the store name display portion 822. When the user works in a plurality of companies or a plurality of stores, a screen for selecting a company and a store is displayed first for the user to select, and after the user's selection, the display proceeds to the login screen 820. In order to make the display transit from the main screen 830 of the company or the store, which is displayed after login on the login screen 820, to the main screen 830 of another company or another store, the main screen 830 may have an operation button (not shown) for instruction of transiting to a selection screen so that transition to the selection screen for selecting another company or another store can be performed on the main screen 830.

The user enters a user ID and a password registered in advance into the user ID input column 823 and the password input column 824 of the login screen 820 and presses the login button 826 thereby making the display screen transit to the main screen 830. In this case, password checking is performed (step S801 in FIG. 10). In the case of error (Y of step S801 in FIG. 10), a message indicating a password error is displayed (step S803 in FIG. 10), and the display screen returns to the login screen 820. When the password is authenticated (N of step S801 in FIG. 10), the display screen is transited to the main screen 830.

User authentication processing may be performed by the server device 60. The server device 60 stores the user master 900 shown in FIG. 16 in the database 50. The server device 60 may perform user authentication processing with reference to the user master 900.

When the end button 828 is pressed on the login screen 820, a confirming termination message is displayed (step S805 in FIG. 10). When the termination has been confirmed (Y of step S807 in FIG. 10), this application is terminated. When the termination is canceled (N of step S807 in FIG. 10), the display screen returns to the login screen 820.

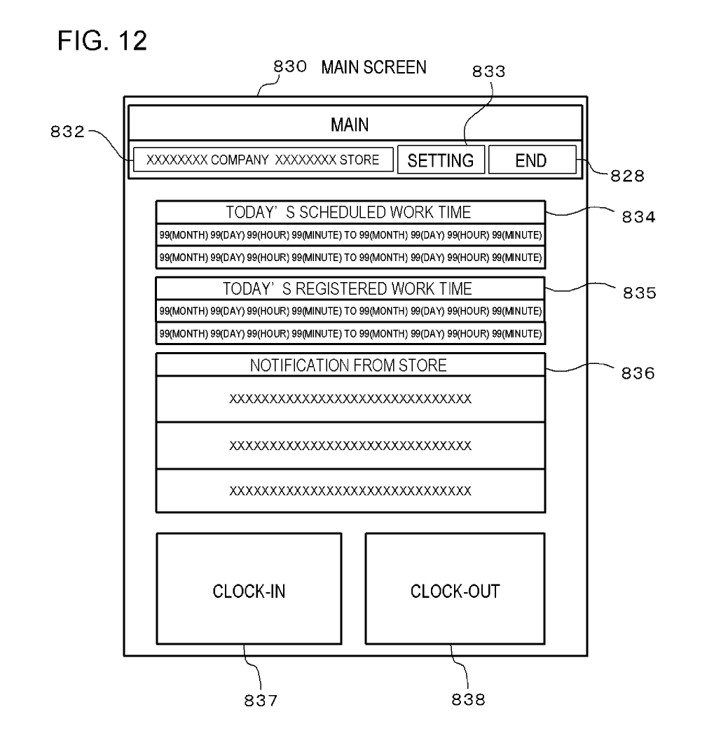

As shown in FIG. 12, the main screen 830 includes a store name display portion 832, a setting button 833, a today's scheduled work time display portion 834, a today's registered work time display portion 835, a store notification display portion 836, a clock-in button 837, a clock-out button 838, and the end button 828.

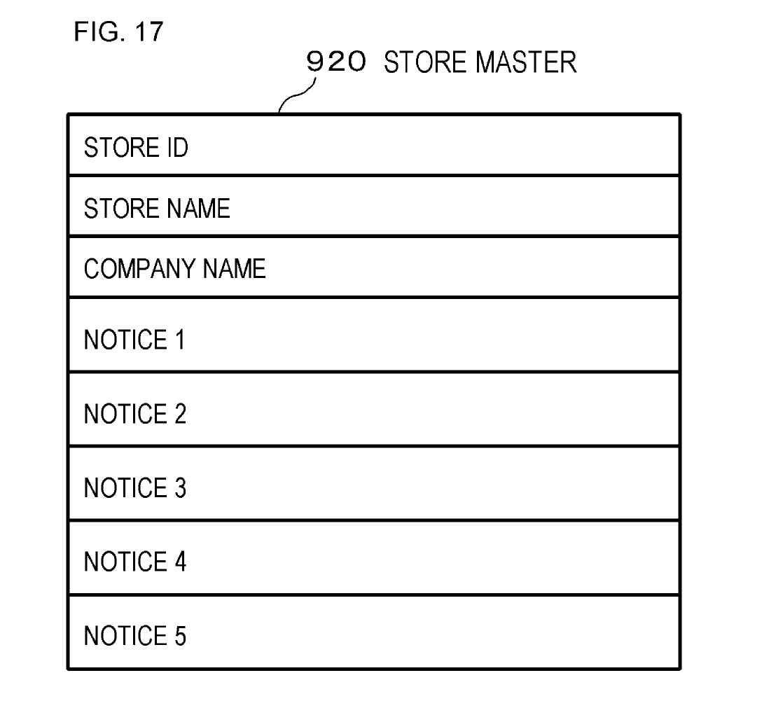

The information of the store name display portion 832, the today's scheduled work time display portion 834, the today's registered work time display portion 835, and the store notification display portion 836 in the main screen 830 may be displayed with reference to the user master 900 in FIG. 16, a store master 920 in FIG. 17, and the like which are stored in the database 50 of the server device 60.

As shown in FIG. 17, the store master 920 stores, for each store ID, a plurality of items including a store name, a company name, and the content desired to be notified to the user, for example.

It is assumed that each of the today's scheduled work time display portion 834, the today's registered work time display portion 835, and the store notification display portion 836 includes a plurality of pieces of information and may be scrolled when the size of the display column is not enough.

As shown in FIG. 10, when the clock-in button 837 or the clock-out button 838 of the main screen 830 is pressed, the display screen is transited to the face authentication screen 860. When the setting button 833 is pressed, the display screen is transited to the initial setting screen 840.

When the end button 828 is pressed on the main screen 830, a confirming transition message is displayed (step S809). When the transition has been confirmed (Y of step S811), this application is transited. When the transition is canceled (N of step S811), the display screen returns to the login screen 830.

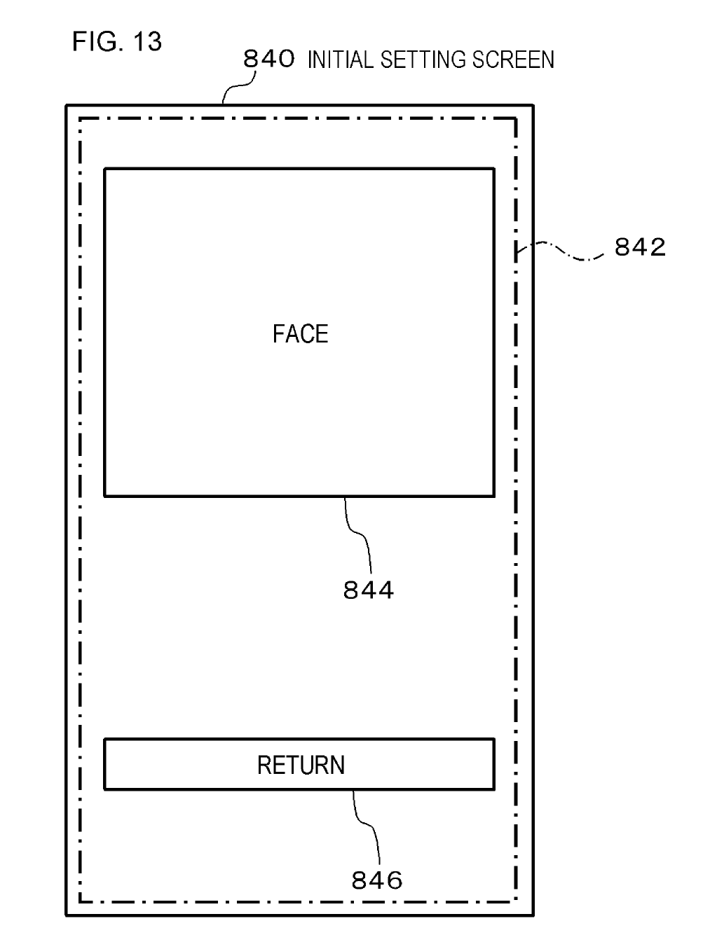

FIG. 13 is a diagram showing an example of the initial setting screen 840 of the present exemplary embodiment. The initial setting screen 840 includes a camera view area 842, a recognized face image display portion 844, and a return button 846.

As described above, in the time and attendance management system 1 of the present exemplary embodiment, the imaging unit 104 of the mobile terminal 10 can be used only when wireless communication between the mobile terminal 10 and the relay device 80 is established. A real-time image captured by the imaging unit 104 of the mobile terminal 10 shown in FIG. 2 is displayed in the camera view area 842.

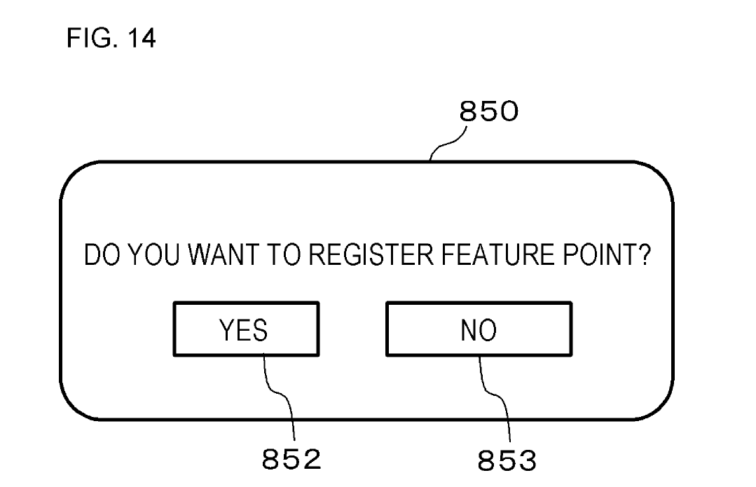

The user directs the camera toward himself or herself so that the face enters the camera view area 842, and captures the face. Then, when the face is recognized from the image by the face recognition unit 134 of the application execution unit 122 shown in FIG. 2 (Y of step S813 in FIG. 10), a still image of the recognized face is displayed in the recognized face image display portion 844, and the screen of a registration confirmation dialog 850 shown in FIG. 14 is displayed (step S815 in FIG. 10). In this case, image data of the still image is temporarily stored in the DRAM 130.

The registration confirmation dialog 850 displays a confirmation message, such as “Do you want to register the feature point?”, and includes a Yes button 852 and a No button 853.

When the Yes button 852 is pressed (Yes of step S817 in FIG. 10), the extraction unit 106 shown in FIG. 2 extracts the feature point from the face image, and the communication unit 124 transmits the feature point data to the relay device 80. Then, the display screen returns to the main screen 830.

When the No button 853 is pressed (No of step S817 in FIG. 10), the display screen returns to the initial setting screen 840, and a real-time image captured by the imaging unit 104 of the mobile terminal 10 shown in FIG. 2 is displayed subsequent to the camera view area 842. When the return button 846 is pressed, the display screen returns to the main screen 830. In addition, when exiting the initial setting screen 840 (camera view area 842), the face image data temporarily stored in the DRAM 130 is erased.

In this manner, the operation of registering the face image of the user in the server device 60 can be performed on the initial setting screen 840. This operation may be performed at least once when continuously using the time and attendance management device 100 of the present exemplary embodiment.

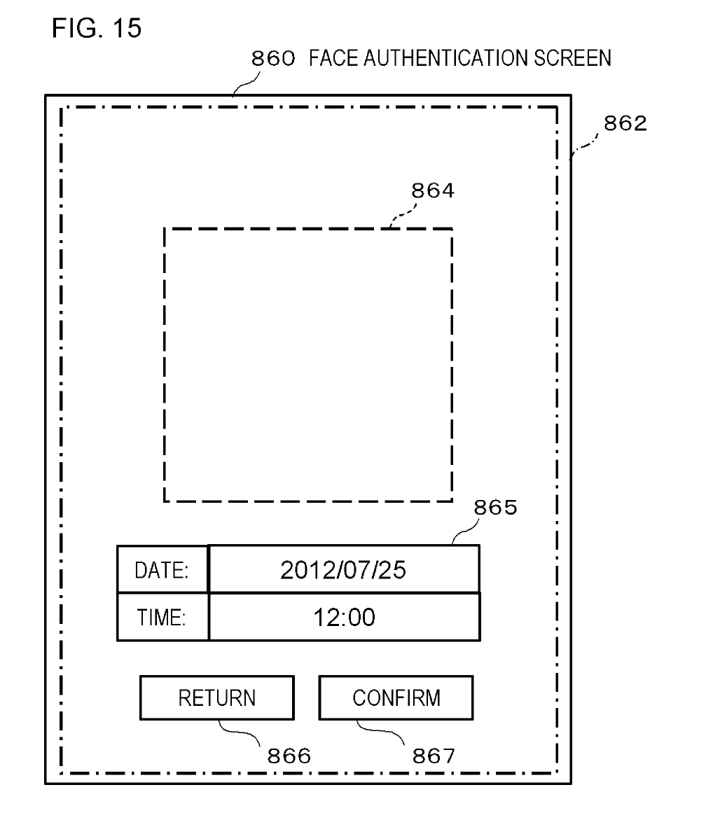

Next, as shown in FIG. 15, the face authentication screen 860 includes a camera view area 862, a recognized face image display portion 864, a current date and time display portion 865, a return button 866, and a confirm button 867.

A real-time image captured by the imaging unit 104 of the mobile terminal 10 shown in FIG. 2 is displayed in the camera view area 862. The user directs the camera toward himself or herself so that the face enters the camera view area 862, and captures the face.

Then, when the face is recognized from the image by the face recognition unit 134 of the application execution unit 122 shown in FIG. 2, a still image of the recognized face is displayed in the recognized face image display portion 864, and the image data of the still image is temporarily stored in the DRAM 130. In this case, an image confirmation step of displaying a screen including a message for making the user confirm the still image, such as the registration confirmation dialog 850 shown in FIG. 14, and making the user confirm the still image may be further included in the screen flow shown in FIG. 10.

The current date and time is displayed in the current date and time display portion 865 shown in FIG. 15. Although this time may be data read from the clock built into the mobile terminal 10 or may be data received from the server device 60 or the relay device 80, it is preferable that the time be a time managed by the server device 60.

When the confirm button 867 is pressed, the display screen is transited to the main screen 830. Date and time displayed in the current date and time display portion 865 of the face authentication screen 860 is displayed in the today's registered work time display portion 835 of the main screen 830 as the clock-in or clock-out time at that time. Here, it is preferable that the time, which is displayed on the screen of the mobile terminal 10 and is recorded in the user master 900, be a time managed by the server device 60.

In addition, when exiting the face authentication screen 860, the face image data temporarily stored in the DRAM 130 is erased.

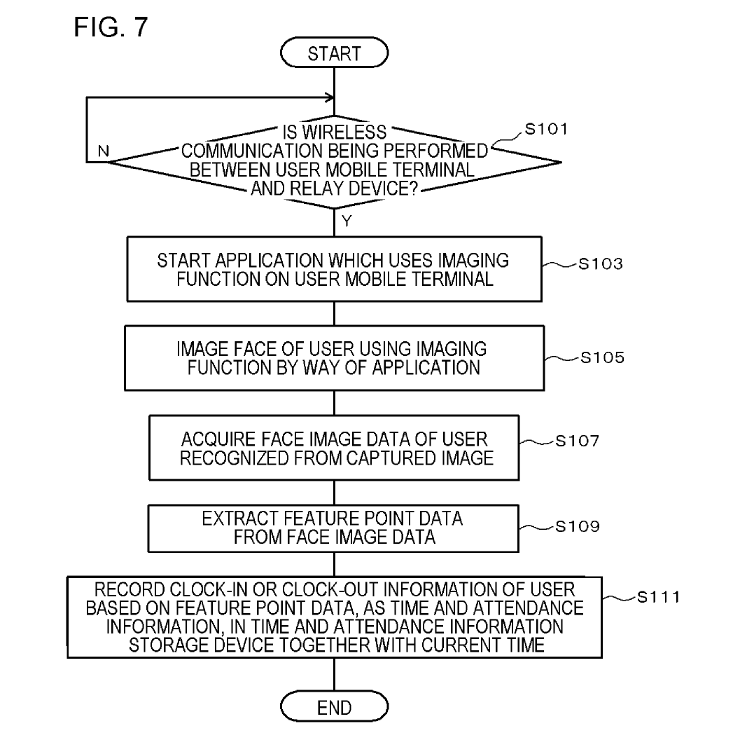

In the above configuration, a data processing method of the time and attendance management device 100 of the present exemplary embodiment will be described below. FIG. 7 is a flowchart showing an example of the operation of the time and attendance management device 100 of the present exemplary embodiment.

As shown in FIG. 7, in the data processing method of the time and attendance management device 100 of the present exemplary embodiment, the time and attendance management device 100 starts an application which uses an imaging function on the mobile terminal 10 (step S103) by allowing the mobile terminal 10 having the imaging function to communicate wirelessly with the relay device 80 provided in a place where the user attends and leaves (YES of step S101), images the face of the user using the imaging function by way of the started application (step S105), acquires face image data of the user recognized from the captured image (step S107), extracts feature point data from the face image data of the user (step S109), and records clock-in or clock-out information of the user based on the feature point data, as time and attendance information, in a time and attendance information storage device (time and attendance information storage unit 112) together with a current time (step S111).

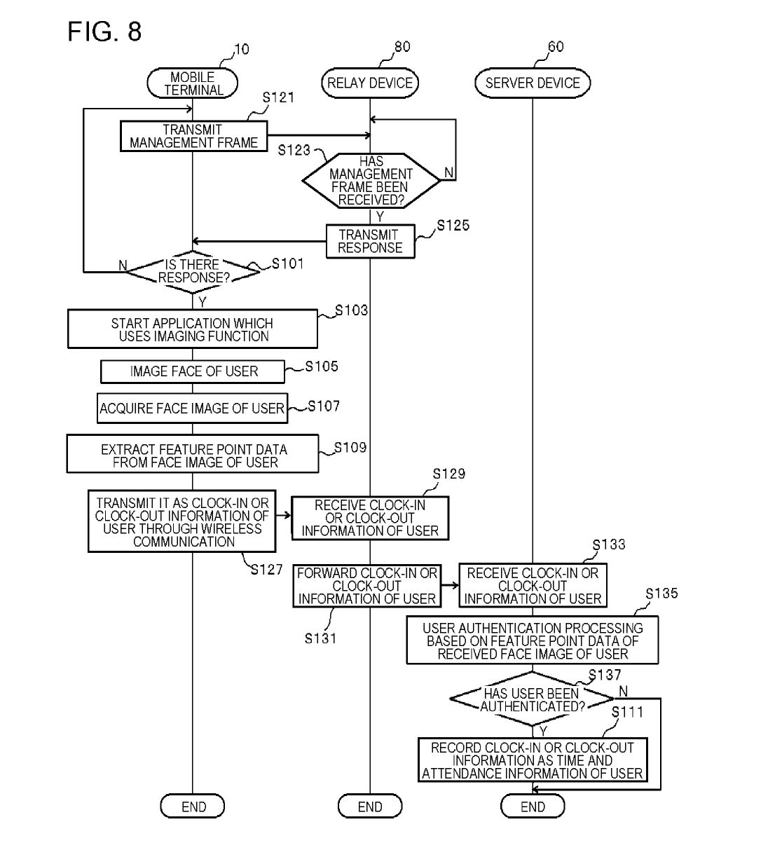

FIG. 8 is a flowchart showing an example of the operation of the time and attendance management system 1 having the exemplary configuration shown in FIG. 5.

This example has configuration when the procedure shown in FIG. 7 is performed, the steps S101 to S109 are executed by the mobile terminal 10, and the step S111 is executed by the server device 60. That is, in the time and attendance management device 100 of the present exemplary embodiment, the mobile terminal 10 performs a process up to the extraction of feature point data of a face image and transmits the feature point data to the server device 60, and the server device 60 records clock-in or clock-out information after user authentication.

Specifically, in the mobile terminal 10, first the communication unit 124 transmits a management frame, for example, ‘Probe Request’ (step S121). When the first communication unit 180 of the relay device 80 receives the management frame (Y of step S123), the first communication unit 180 transmits a response, for example, ‘Probe Response’, to the mobile terminal 10 (step S125).

Then, when the mobile terminal 10 receives the response from the relay device 80 (Y of step S101), the control unit 102 controls the application execution unit 122 to start the application (step S103).

In this case, as described above, the login screen 820 (FIG. 11) is displayed on the mobile terminal 10, and the display screen is transited to the main screen 830 (FIG. 12) after user authentication processing. When the user presses the clock-in button 837 of the main screen 830, the display screen is transited to the face authentication screen 860 (FIG. 15). Accordingly, the mobile terminal 10 enters a shooting mode of a face photo for face authentication at the time of the clock-in. The user captures the user's own face using the imaging unit 104 (step S105). Then, the face recognition unit 134 shown in FIG. 6 recognizes the face of the user, and acquires a face image (step S107).

Then, the extraction unit 106 extracts feature point data from the face image of the user (step S109). Then, the communication unit 124 transmits the feature point data, as clock-in or clock-out information of the user, to the relay device 80 through wireless LAN communication (step S127).

The first communication unit 180 of the relay device 80 receives the clock-in or clock-out information of the user from the mobile terminal 10 (step S129). Then, the second communication unit 182 forwards the clock-in or clock-out information to the server device 60 (step S131).

In the server device 60, the communication unit 162 receives the clock-in or clock-out information of the user that has been transmitted from the relay device 80 through the network 3 (step S133). Then, the authentication unit 164 performs user authentication processing by collating the received feature point data with the feature point data of the user registered in advance in the user master 900 (step S135). When the authentication unit 164 confirms that the received feature point data matches the user (Y of step S137), the recording unit 110 records the clock-in or clock-out information (here, attendance or leaving time) as the time and attendance information of the user in the time and attendance information storage unit 112 (step S111).

As described above, according to the time and attendance management device 100 of the exemplary embodiment of the present invention, it is possible to prevent an improper act, such as impersonation of clock-in and clock-out, while suppressing the cost by not having to introduce an expensive device, such as a biometric authentication machine, into the store 5.

In addition, if the time and attendance management device 100 is configured to transmit only the feature point data from the mobile terminal 10, it is possible to guarantee security since the personal information of the user, such as a face photo, is not handled.

### Second Exemplary Embodiment

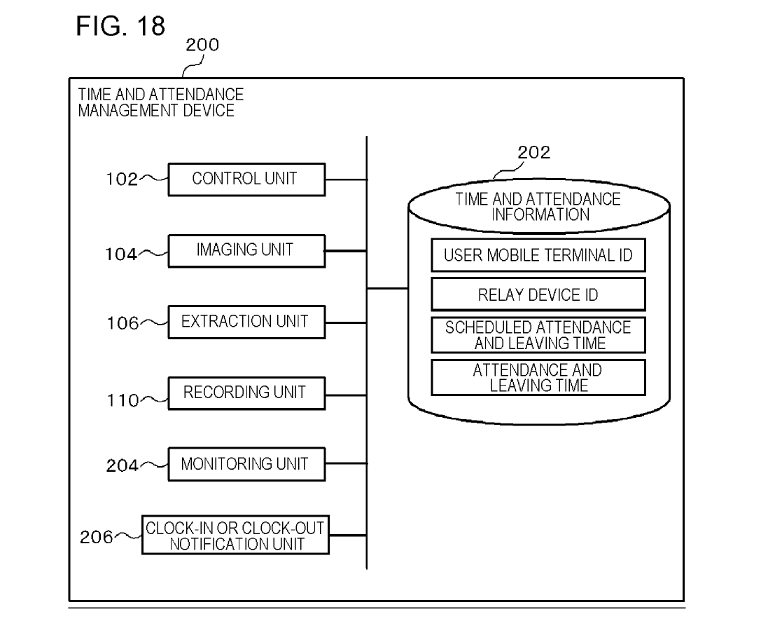

FIG. 18 is a functional block diagram showing the configuration of a time and attendance management device 200 according to the exemplary embodiment of the present invention.

The time and attendance management device 200 of the present exemplary embodiment is different from the time and attendance management device 100 of the above exemplary embodiment shown in FIG. 2 in that the time and attendance management device 200 has a configuration to prompt a user to clock in or clock out based on the scheduled attendance and leaving time registered in advance.

The time and attendance management device 200 of the present exemplary embodiment further includes a monitoring unit 204 and a clock-in or clock-out notification unit 206 in addition to the configuration of the time and attendance management device 100 of the above exemplary embodiment shown in FIG. 2.

In the time and attendance management device 200 of the present exemplary embodiment, a time and attendance information storage unit 202 stores the scheduled attendance and leaving time of the user and the identification information (relay terminal ID) of the relay device 80 provided in a place where the user attends and leaves so as to be associated with the identification information (user mobile terminal ID) of the user mobile terminal.

In addition, the time and attendance management device 200 further includes the monitoring unit 204 that monitors whether or not it is the time to prompt the user to perform a clock-in or clock-out operation based on the scheduled attendance and leaving time of the user with reference to the time and attendance information storage unit 202 and the clock-in or clock-out notification unit 206 that transmits notification prompting the clock-in or clock-out operation to the mobile terminal 10 through the relay device 80 provided in a place where the user attends and leaves.

In the present exemplary embodiment, for example, the server device 60 may include the monitoring unit 204 and the clock-in or clock-out notification unit 206. In other exemplary embodiments, the mobile terminal 10 may store the scheduled attendance and leaving time in a memory, and may include the monitoring unit 204 and the clock-in or clock-out notification unit 206.

In the present exemplary embodiment, for example, the time to prompt the user to perform a clock-in or clock-out operation may be set in advance earlier than the scheduled attendance and leaving time of the user stored in the time and attendance information storage unit 202 by a predetermined time, for example, by 5 to 10 minutes. The user may designate the predetermined time through the mobile terminal 10, or the administrator of the server device 60 may set the predetermined time arbitrarily, or a person in charge of the store 5 may set the predetermined time arbitrarily. Since the setting method is not related to the essence of the present invention, detailed explanation thereof will not be repeated.

For example, clock-in or clock-out notification times of users may be set so as to be shifted from each other on the server device 60 side, so that notification times for users of the same attendance and leaving time are shifted from each other. In general, attendance and leaving times in most of the stores 5 are approximately the same. Therefore, it is expected that the clock-in or clock-out operations of a plurality of users will be concentrated at the same time. If the notification times for the users are set so as to be shifted from each other, the concentration of the clock-in or clock-out operations of the plurality of users may be able to be avoided. Therefore, the load concentration before and after the attendance and leaving time on the server device 60 or the relay device 80 side may be able to be prevented.

When the current time is a predetermined time earlier than the scheduled attendance and leaving time of the user stored in the time and attendance information storage unit 202, the monitoring unit 204 notifies the clock-in or clock-out notification unit 206 of the situation.

In response to the notification from the monitoring unit 204, the clock-in or clock-out notification unit 206 transmits notification prompting a clock-in or clock-out operation to the mobile terminal 10 through the relay device 80 provided in a place where the user attends and leaves.

The notification prompting the clock-in or clock-out operation is, for example, that the clock-in or clock-out notification unit 206 transmits a push message from the server device 60 to the mobile terminal 10 through the relay device 80 and the message pops up on the display unit 26 (FIG. 3) of the mobile terminal 10. For example, the clock-in or clock-out notification unit 206 displays a message, such as “It is attendance time. Please clock in”, on the mobile terminal 10. In this case, in order to notify the user of the reception of the message, the clock-in or clock-out notification unit 206 may cause the mobile terminal 10 to output a voice, vibration, or the like.

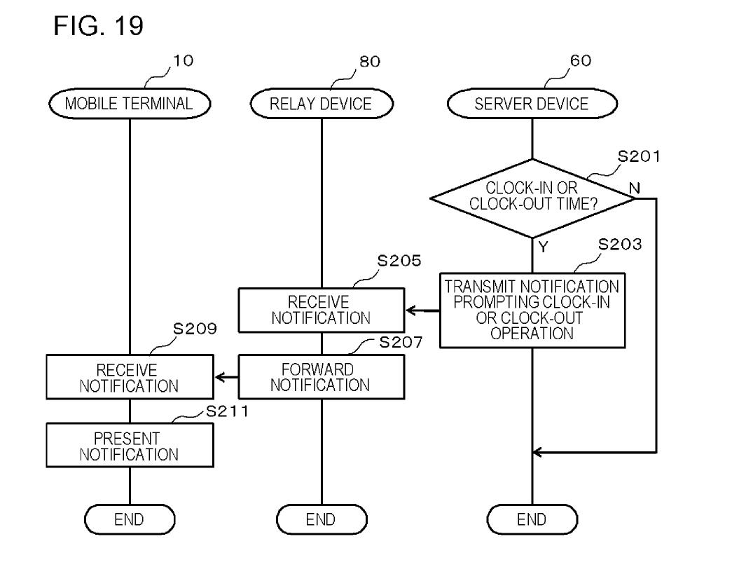

The operation of the time and attendance management device 200 of the present exemplary embodiment thus configured in this manner will be described below. FIG. 19 is a flowchart showing an example of the operation of the time and attendance management device 200 of the present exemplary embodiment.

First, in the server device 60, the monitoring unit 204 monitors whether or not it is the time to prompt the user to perform a clock-in or clock-out operation based on the scheduled attendance and leaving time of the user with reference to the time and attendance information storage unit 202 (step S201).

Then, when it is the attendance or leaving time (Y of step S201), the clock-in or clock-out notification unit 206 transmits notification prompting the clock-in or clock-out operation to the mobile terminal 10 through the relay device 80 (step S203).

The relay device 80 receives the notification from the server device 60 (step S205), and forwards the notification to the mobile terminal 10 (step S207). Here, the second communication unit 182 of the relay device 80 shown in FIG. 5 receives the notification from the server device 60, and the first communication unit 180 forwards the notification to the mobile terminal 10, for example.

Then, the mobile terminal 10 receives the notification (step S209), and presents the notification to the user (step S211). Here, the communication unit 124 shown in FIG. 5 receives the notification, and the application execution unit 122 displays the received notification on the display unit 26 shown in FIG. 3, for example.

As described above, according to the time and attendance management device 200 according to the exemplary embodiment of the present invention, it is possible to achieve the same effect as in the exemplary embodiment described above and to prevent forgetting to clock in or clock out. In addition, if the clock-in or clock-out notification time is set so as to be shifted from each user, it is possible to avoid the load concentration of the clock-in or clock-out processing.

### Third Exemplary Embodiment

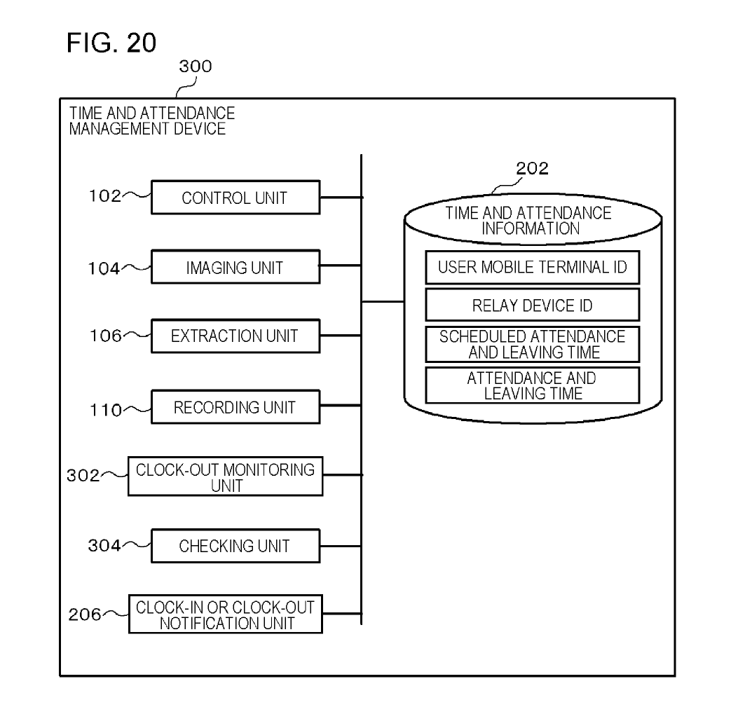

FIG. 20 is a functional block diagram showing the configuration of a time and attendance management device 300 according to the exemplary embodiment of the present invention.

The time and attendance management device 300 of the present exemplary embodiment is different from the time and attendance management device 100 of the above exemplary embodiment shown in FIG. 2 in that the time and attendance management device 300 has a configuration to record a leaving time automatically when a user has forgotten to clock out and has departed for home.

The time and attendance management device 300 of the present exemplary embodiment further includes a clock-out monitoring unit 302 and a checking unit 304 in addition to the configuration of the time and attendance management device 100 of the above exemplary embodiment shown in FIG. 2.

In the present exemplary embodiment, in the same manner as in FIG. 18, the time and attendance information storage unit 202 includes a user mobile terminal ID, a relay terminal ID, user's scheduled attendance and leaving time, and the actual attendance and leaving time.

In addition, the time and attendance management device 300 of the present exemplary embodiment may also include the configuration of the time and attendance management device 200 shown in FIG. 18.

The time and attendance management device 300 of the present exemplary embodiment further includes the clock-out monitoring unit 302 that monitors whether or not the clock-out information of the user has been recorded in the time and attendance information storage unit 202 after a predetermined time has passed from the leaving time of the user, based on the scheduled attendance and leaving time of the user with reference to the time and attendance information storage unit 202 and the checking unit 304 that makes the relay device 80 provided in a place where the user attends and leaves check the presence of the mobile terminal 10 when the clock-out information of the user has not been recorded in the time and attendance information storage unit 202.

When the result of presence checking indicates that the mobile terminal 10 is not present, the recording unit 110 records the current time in the time and attendance information storage unit 202 as clock-out information of the mobile terminal 10.

In the present exemplary embodiment, for example, the function of the clock-out monitoring unit 302 may be realized by the server device 60, and the function of the checking unit 304 may be realized by the combination of the server device 60 and the relay device 80.

In the present exemplary embodiment, the predetermined time of the clock-out monitoring unit 302 may be set in advance to about 3 to 15 minutes, for example. The administrator of the server device 60 may set the predetermined time arbitrarily, or a person in charge of the store 5 may set the predetermined time arbitrarily. Since the setting method is not related to the essence of the present invention, detailed explanation thereof will not be repeated.

The clock-out monitoring unit 302 monitors whether or not the current time has passed the scheduled attendance and leaving time of the user stored in the time and attendance information storage unit 202 by the predetermined time, and monitors whether or not the clock-out information has been recorded in the time and attendance information storage unit 202 after the passage of the predetermined time. Alternatively, the clock-out monitoring unit 302 may monitor whether or not the clock-out information has been recorded in the time and attendance information storage unit 202 during the predetermined time from the scheduled attendance and leaving time of the user. When the clock-out information has not been recorded in the time and attendance information storage unit 202, the clock-out monitoring unit 302 notifies the checking unit 304 of the situation.

The checking unit 304 receives the notification, and makes the relay device 80 provided in a place where the user attends and leaves check the presence of the mobile terminal 10.

Various checking methods may be considered. For example, the relay device 80 may detect that the mobile terminal 10 is present in the wireless communication area by receiving the management frame of the wireless LAN that is irregularly transmitted from the mobile terminal 10.

Alternatively, the checking unit 304 may detect which mobile terminal 10 is present in the wireless communication area by causing the relay device 80 to broadcast a beacon to the unspecified mobile terminal 10, which may be present in the communication area and to communicate with the mobile terminal 10 that has sent a response.

When it is confirmed that the mobile terminal 10 is not present in the wireless communication area, the checking unit 304 notifies the recording unit 110 of the situation.

When the result of presence checking indicates that the mobile terminal 10 is not present in the wireless communication area, the recording unit 110 records the current time in the time and attendance information storage unit 202 as clock-out information of the mobile terminal 10.

Thus, the time and attendance management device 300 of the present exemplary embodiment can automatically record the leaving time of the user who has forgotten to clock out and has departed for home. In addition, the recording unit 110 may store information (for example, a flag), which indicates that the leaving time has been automatically recorded, in the time and attendance information storage unit 202 so as to be associated with leaving time information.

In addition, the time and attendance management device 300 of the present exemplary embodiment may have a configuration (not shown) to notify the administrator of the server device 60, a person in charge of the store 5, or the mobile terminal 10 that the leaving time has been automatically recorded due to forgetting to clock out. The time and attendance management device 300 of the present exemplary embodiment may have a configuration (not shown) to transmit notification to a computer or the like that is provided in the store 5 and is connected to the relay device 80.

As a notification method, the time and attendance management device 300 may transmit a push message thereby displaying a message on the display unit of each device (the mobile terminal 10, the relay device 80, the server device 60, or a management computer provided in the store 5) by pop-up display, or the notification of e-mail to the e-mail address of the store 5 registered in advance is also possible. In addition, the time and attendance management device 300 may display that a user has forgotten to clock out last time and has departed for home, as a notification from the store 5, on the store notification display portion 836 of the main screen 830 of the mobile terminal 10.

In addition, the time and attendance management device 300 of the present exemplary embodiment may further include the clock-in or clock-out notification unit 206 similar to the time and attendance management device 200 shown in FIG. 18. When it is confirmed by the checking unit 304 that the mobile terminal 10 is present in the wireless communication area of the relay device 80, the clock-in or clock-out notification unit 206 can transmit notification prompting a clock-out operation to the mobile terminal 10 through the relay device 80 provided in a place where the user attends and leaves.

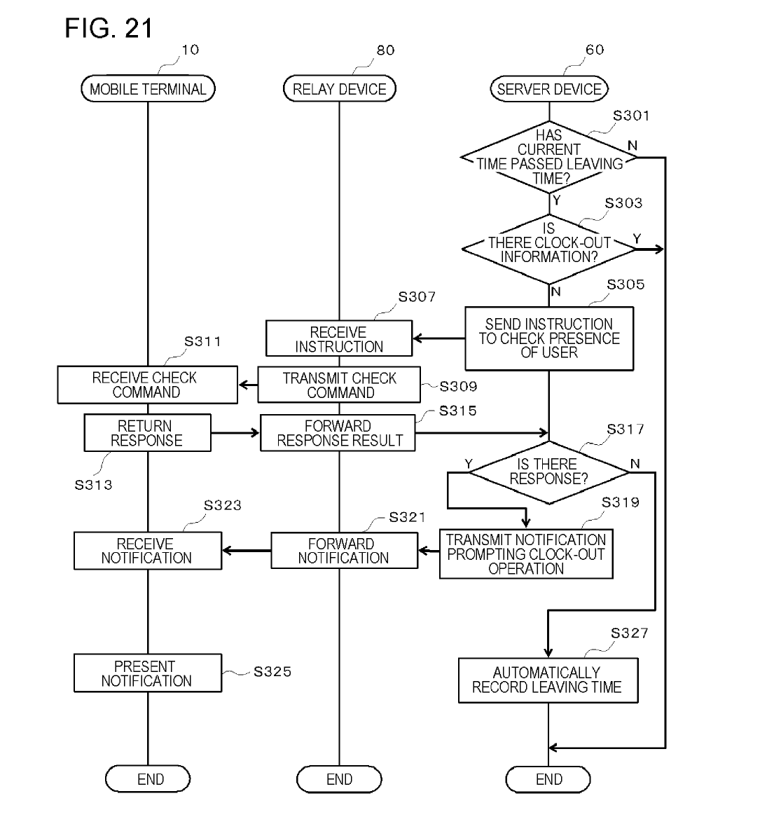

The operation of the time and attendance management device 300 according to the exemplary embodiment of the present invention configured in this manner will be described below. FIG. 21 is a flowchart showing an example of the operation of the time and attendance management device 300 according to the present exemplary embodiment.

First, in the server device 60, the clock-out monitoring unit 302 determines whether or not the current time has passed the scheduled leaving time of the user, who is already at work, by a predetermined time or more (step S301). When the current time has passed the scheduled leaving time by the predetermined time or more (Y of step S301), the checking unit 304 checks whether or not the leaving time of the user has been recorded with reference to the time and attendance information storage unit 202 (step S303). When the leaving time has been recorded (Y of step S303), this process is terminated.

When the leaving time has not been recorded (N of step S303), the checking unit 304 instructs the relay device 80 provided in the store 5 where the user to be checked works to check whether or not the user is present in the store 5 (step S305). In the relay device 80, the second communication unit 182 receives the instruction from the server device 60 (step S307), and the first communication unit 180 transmits a check command to the mobile terminal 10 (step S309). As described above, for example, a beacon signal is broadcast from the relay device 80, and a response from the mobile terminal 10 that has received the beacon signal is awaited.

In the mobile terminal 10, the communication unit 124 receives the check command from the relay device 80 (step S311), and returns a response (step S313). The relay device 80 receives the response from the mobile terminal 10, and forwards a response result to the server device 60 (step S315). Here, when there is no response from the mobile terminal 10, the fact is notified to the server device 60, as a response result, from the relay device 80.

In the checking unit 304, the relay device 80 may confirm that the mobile terminal 10 that has sent a response belongs to the target user based on the identification information of the mobile terminal 10 of the user notified in advance from the server device 60. Alternatively, in the checking unit 304, the relay device 80 may transmit the identification information of the mobile terminal 10, which has sent a response, to the server device 60, and the mobile terminal 10 that is present may be checked on the server device 60 side.

Alternatively, in the checking unit 304, the server device 60 or the relay device 80 may designate the mobile terminal 10 to be searched for from the start and transmit a check command, and only the mobile terminal 10 to be searched for may transmit a response.

When the response from the mobile terminal 10 to be searched for is confirmed based on the response result received from the relay device 80 (Y of step S317), the server device 60 transmits notification prompting the clock-in or clock-out operation to the mobile terminal 10 through the relay device 80 (step S319). In the relay device 80, the second communication unit 182 receives the notification from the server device 60, and the first communication unit 180 forwards the notification to the mobile terminal 10 (step S321). The mobile terminal 10 receives the notification (step S323), and displays the notification on the display unit 26 shown in FIG. 3 (step S325).

On the other hand, when there is no response from the mobile terminal 10 to be searched for (N of step S317), the recording unit 110 in the server device 60 automatically records the leaving time of the target mobile terminal 10 in the time and attendance information storage unit 202 (step S327). In this case, it is preferable that the recording unit 110 record the leaving time of the target mobile terminal 10 so as to be associated with information indicating that the leaving time of the target mobile terminal 10 has been automatically recorded instead of being recorded by the clock-in or clock-out operation of the user.

In addition, the time and attendance management device 300 may have a configuration to notify the administrator of the server device 60 or a person in charge of the store 5 that the leaving time has been automatically recorded due to forgetting to clock in or clock out.

As described above, according to the time and attendance management device 300 of the present exemplary embodiment, it is possible to achieve the same effect as in the exemplary embodiments described above and to record the leaving time automatically when the user has forgotten to clock out and has departed for home. In addition, it is possible to prompt a user remaining in the store 5 past the scheduled leaving time to clock out.

### Fourth Exemplary Embodiment

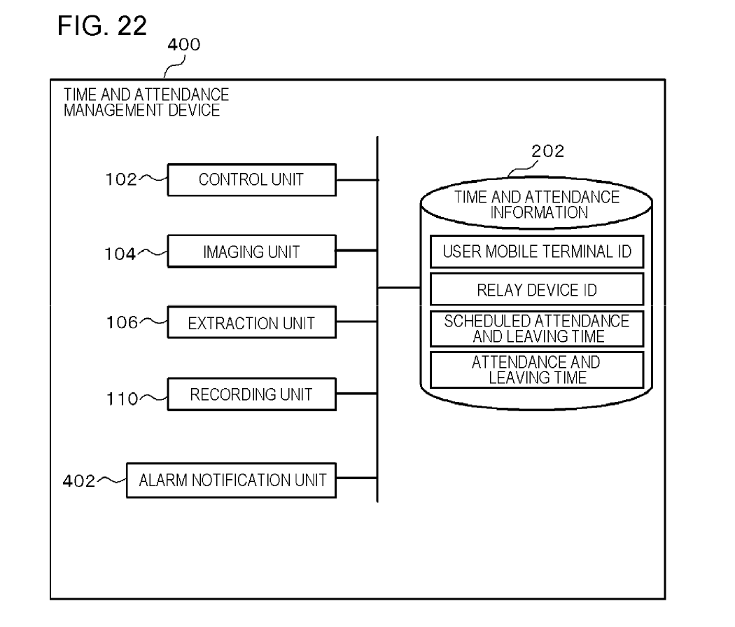

FIG. 22 is a functional block diagram showing the configuration of a time and attendance management device 400 according to the exemplary embodiment of the present invention.

The time and attendance management device 400 of the present exemplary embodiment is different from the time and attendance management device 100 of the above exemplary embodiment shown in FIG. 2 in that the time and attendance management device 400 has a configuration to notify a user of the next attendance date and time.

The time and attendance management device 400 of the present exemplary embodiment further includes an alarm notification unit 402 in addition to the configuration of the time and attendance management device 100 of the above exemplary embodiment shown in FIG. 2.

In the present exemplary embodiment, in the same manner as in FIG. 18, the time and attendance information storage unit 202 includes a user mobile terminal ID, a relay terminal ID, user's scheduled attendance and leaving time, and the actual attendance and leaving time.

In addition, the time and attendance management device 400 of the present exemplary embodiment may also include the configuration of the time and attendance management device 200 or the time and attendance management device 300 in the above exemplary embodiment shown in FIG. 18 or 20.

The time and attendance management device 400 of the exemplary embodiment of the present invention further includes a notification unit (alarm notification unit 402) that transmits alarm notification prompting the user to attend work to the mobile terminal 10 through the relay device 80, which is provided in a place where the user attends and leaves, at a predetermined time before the scheduled attendance time based on the scheduled attendance and leaving time of the user with reference to the time and attendance information storage unit 202.

In the present exemplary embodiment, the predetermined time of the alarm notification unit 402 may be set in advance to a week, several days, a day, and an hour, for example. The user may designate the predetermined time through the mobile terminal 10, or the user or the administrator of the server device 60 may set the predetermined time arbitrarily, or a person in charge of the store 5 may set the predetermined time arbitrarily. Since the setting method is not related to the essence of the present invention, detailed explanation thereof will not be repeated.

In the present exemplary embodiment, for example, the server device 60 may include the alarm notification unit 402. In other exemplary embodiments, the mobile terminal 10 may store the scheduled attendance and leaving time in a memory to realize the alarm notification unit 402.

The alarm notification unit 402 monitors whether or not the current time is an alarm time based on the scheduled attendance and leaving time of the user, and when the current time is the alarm time, performs processing for causing the user to check the user's attendance schedule. In this case, the alarm notification unit 402 may transmit a push message thereby displaying a message on the display unit of each device (the mobile terminal 10, the relay device 80, the server device 60, or a management computer provided in the store 5) by pop-up display, or the notification may be e-mailed to the e-mail address of the store 5 registered in advance.

The message may include the next scheduled attendance time, today's scheduled leaving time, scheduled attendance time period (attendance and leaving time), information of the attendance destination store, a message prompting the user to attend work, and the like. In addition, the message may include information desired to be notified to the user, such as a change of the workplace.

For example, the alarm notification unit 402 displays on the mobile terminal 10 a message, such as “Your next work schedule is Jul. 20, 2012. Please make sure to attend work”, “You are scheduled to work from 10:00 to 17:00 today. Please make sure to attend store A”, or “It is almost time to leave”. In this case, in order to notify the user of the reception of the message, the alarm notification unit 402 may cause the mobile terminal 10 to output a voice, vibration, or the like.

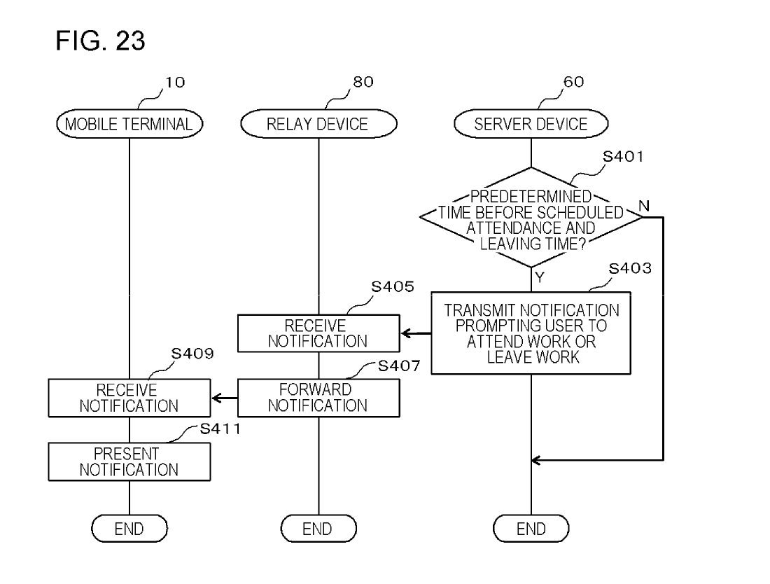

The operation of the time and attendance management device 400 of the present exemplary embodiment thus configured in this manner will be described below. FIG. 23 is a flowchart showing an example of the operation of the time and attendance management device 400 of the present exemplary embodiment.

First, in the server device 60, the alarm notification unit 402 determines whether or not the current time is a predetermined time before the scheduled attendance or leaving time of the user with reference to the time and attendance information storage unit 202 (step S401). When the current time is the predetermined time before the scheduled attendance and closing time of the user (Y of step S401), the alarm notification unit 402 transmits notification prompting the user to attend work or leave work to the mobile terminal 10 through the relay device 80 (step S403).

In this case, the alarm notification unit 402 transmits the notification to the relay device 80 provided in the store 5 where the user works.

In the relay device 80, the second communication unit 182 receives the notification from the server device 60 (step S405), and the first communication unit 180 forwards the notification to the mobile terminal 10 (step S407).

The mobile terminal 10 receives the notification from the server device 60 through the relay device 80 (step S409), and displays the notification on the display unit 26 shown in FIG. 3 (step S411).

In addition, when the user is not present in the store 5 or when the mobile terminal 10 of the user is not present in the communication area of the relay device 80, it is not possible to transmit the notification to the mobile terminal 10 through the relay device 80. Therefore, the time and attendance management device 400 may further have a configuration in which the relay device 80 checks that there is no response from the mobile terminal 10 and notifies the server device 60 of the result and the alarm notification unit 402 transmits an e-mail including the above message to the e-mail address registered in advance by the user.

As described above, according to the time and attendance management device 400 of the present exemplary embodiment, it is possible to achieve the same effect as in the exemplary embodiments described above. In addition, since it is possible to notify the user of attendance and leaving schedules based on the scheduled attendance and leaving time of the user, it is possible to prompt the user to attend work or leave work in advance.

### Fifth Exemplary Embodiment

The time and attendance management device of the present exemplary embodiment is different from the time and attendance management device 100 of the above exemplary embodiment shown in FIG. 2 in that it is detected and recorded in which store 5 the mobile terminal 10 is present.

The time and attendance management device of the present exemplary embodiment may include the configuration of at least one of the time and attendance management device 100 of the above exemplary embodiment shown in FIG. 2, the time and attendance management device 200 of the above exemplary embodiment shown in FIG. 18, the time and attendance management device 300 of the above exemplary embodiment shown in FIG. 20, and the time and attendance management device 400 of the above exemplary embodiment shown in FIG. 22 and the configuration of the combination thereof.

In the time and attendance management device of the present exemplary embodiment, when the mobile terminal 10 present in the wireless communication area of the relay device 80 communicates wirelessly with the relay device 80, the control unit 102 starts an application on the mobile terminal 10, and the recording unit 110 acquires the identification information of the mobile terminal 10 and the identification information of the relay device 80 and records the pieces of information in a time and attendance information storage device (the time and attendance information storage unit 112 or the time and attendance information storage unit 202) so as to be associated with each other.

In the present exemplary embodiment, the recording unit 110 may further store the identification information of the relay device 80 in the store master 920 shown in FIG. 17 so as to match the store ID. In addition, the recording unit 110 may further record the recording time or the information acquisition time in the time and attendance information storage unit 112 or the time and attendance information storage unit 202 so as to be associated with the information therein.

In the time and attendance management device of the present exemplary embodiment, based on the acquired identification information of the mobile terminal 10 and the acquired identification information of the relay device 80, for example, the server device 60 may record the information of the store 5 where the user works so as to be associated with the acquired identification information of the mobile terminal 10 and the acquired identification information of the relay device 80. In addition, the server device 60 may have a configuration to determine whether or not the mobile terminal 10 is present at a position in the proper store 5 from the acquired identification information of the relay device 80. When a mismatch with the registered store 5 occurs, the server device 60 may have a configuration to notify a person in charge of the store 5 or the user of the mismatch.

In addition, the server device 60 may have a configuration to automatically register the store where the user works in the time and attendance information storage unit 112 or the time and attendance information storage unit 202 based on the identification information of the relay device 80.

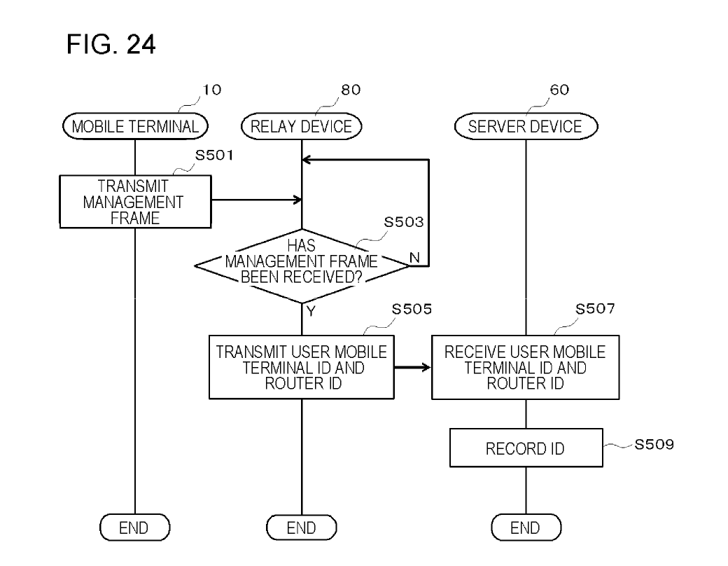

FIG. 24 is a flowchart showing an example of the operation of the time and attendance management device of the present exemplary embodiment.

First, in the mobile terminal 10, the communication unit 124 transmits a management frame periodically or at an arbitrary timing (step S501). When the first communication unit 180 of the relay device 80 receives the management frame (Y of step S503), the identification information (ID) of the mobile terminal 10 is acquired, and the second communication unit 182 transmits its own identification information (router ID) to the server device 60 (step S505). In the server device 60, the communication unit 162 receives the identification information of the mobile terminal 10 and the identification information of the relay device 80 from the relay device 80 (step S507), and the recording unit 110 records the information in the time and attendance information storage unit 112 or the time and attendance information storage unit 202 (step S509).

As described above, according to the time and attendance management device of the present exemplary embodiment, it is possible to achieve the same effect as in the exemplary embodiments described above and to acquire the identification information of the mobile terminal 10 and the relay device 80 and record the pieces of information so as to be associated with each other.

While the exemplary embodiments of the present invention have been described with reference to the diagrams, these are only illustration of the present invention, and other various configurations may also be adopted.

For example, in other exemplary embodiments, a time and attendance management device may further include a presence checking unit (not shown) that transmits notification prompting a punching operation for presence checking to the mobile terminal 10 through the relay device 80 at an arbitrary timing within a period of time, during which the user should be in a place where the user attends and leaves, based on the time and attendance information of the user with reference to the time and attendance information storage unit 112 or the time and attendance information storage unit 202.

According to this configuration, it is possible to perform an unannounced test regarding whether or not the user is at the workplace within the attendance time.

In the above exemplary embodiment, the configuration has been described in which the extraction unit extracts feature point data from the captured face image data of the user as clock-in or clock-out information and the authentication unit performs user identification based on the feature point data. In other exemplary embodiments, a time and attendance management device may be configured to include an image recognition unit that collates the feature quantity (feature point data) in the captured image with the feature quantity (feature point data) of the face image of the user registered in advance by pattern recognition or the like and acquires the feature point data as clock-in or clock-out information when there is a match. Thus, the authentication processing and the extraction of feature point data may be performed together.

While the invention has been particularly shown and described with reference to exemplary embodiments thereof, the invention is not limited to these exemplary embodiments. It will be understood by those of ordinary skill in the art that various changes in form and details may be made therein without departing from the spirit and scope of the present invention as defined by the claims.

In addition, in the present invention, when acquiring and using the information regarding a user, it is assumed that the acquisition and use are legally performed.

Examples of a reference form are added below.

1. A data processing method of a time and attendance management device, including:

starting, by the time and attendance management device, an application which uses an imaging function on a user mobile terminal by allowing the user mobile terminal having the imaging function to communicate wirelessly with a relay device provided in a place where a user attends and leaves;

imaging, by the time and attendance management device, a face of the user using the imaging function by way of the started application;

acquiring, by the time and attendance management device, face image data of the user recognized from a captured image;

extracting, by the time and attendance management device, feature point data from the face image data of the user; and

recording, by the time and attendance management device, clock-in or clock-out information of the user based on the feature point data, as time and attendance information, in a time and attendance information storage device together with a current time.

2. The data processing method of the time and attendance management device described in 1, in which the time and attendance information storage device stores scheduled attendance and leaving time of the user and identification information of the relay device provided in the place where the user attends and leaves so as to be associated with identification information of the user mobile terminal, and

the data processing method including:

monitoring, by the time and attendance management device, whether or not the current time is a time to prompt the user to perform a clock-in or clock-out operation based on the scheduled attendance and leaving time of the user with reference to the time and attendance information storage device; and

transmitting, by the time and attendance management device, notification prompting the clock-in or clock-out operation to the user mobile terminal through the relay device provided in the place where the user attends and leaves when the current time is the time to prompt the user to perform the clock-in or clock-out operation.

3. The data processing method of the time and attendance management device described in 1 or 2, in which the time and attendance information storage device stores scheduled attendance and leaving time of the user and identification information of the relay device provided in the place where the user attends and leaves so as to be associated with identification information of the user mobile terminal, and

the data processing method including:

monitoring, by the time and attendance management device, whether or not clock-out information of the user has been recorded in the time and attendance information storage device after a predetermined time has passed from leaving time of the user based on the scheduled attendance and leaving time of the user with reference to the time and attendance information storage device;

making, by the time and attendance management device, the relay device provided in the place where the user attends and leaves check presence of the user mobile terminal when the clock-out information of the user has not been recorded in the time and attendance information storage device; and

recording, by the time and attendance management device, a current time is recorded in the time and attendance information storage device as clock-out information of the user mobile terminal when a result of the presence checking indicates that the user mobile terminal is not present.

4. The data processing method of the time and attendance management device described in 3, including transmitting, by the time and attendance management device, notification prompting a clock-in or clock-out operation to the user mobile terminal through the relay device provided in the place where the user attends and leaves when the time and attendance management device confirms that the user mobile terminal is present.

5. The data processing method of the time and attendance management device described in any one of 1 to 4, in which the time and attendance information storage device stores scheduled attendance and leaving time of the user and identification information of the relay device provided in the place where the user attends and leaves so as to be associated with identification information of the user mobile terminal, and

the data processing method including:

transmitting, by the time and attendance management device, alarm notification prompting the user to attend work to the user mobile terminal through the relay device, which is provided in the place where the user attends and leaves, at a predetermined time before the scheduled attendance time based on the scheduled attendance and leaving time of the user with reference to the time and attendance information storage device.

6. The data processing method of the time and attendance management device described in any one of 1 to 5, including transmitting, by the time and attendance management device, notification prompting a punching operation for presence checking to the user mobile terminal through the relay device at an arbitrary timing within a period of time, during which the user is to be in the place where the user attends and leaves, based on the time and attendance information of the user with reference to the time and attendance information storage device.

7. The data processing method of the time and attendance management device described in any one of 1 to 6, including:

starting, by the time and attendance management device, the application on the user mobile terminal when the user mobile terminal present in a wireless communication area of the relay device communicates wirelessly with the relay device; and

acquiring, by the time and attendance management device, identification information of the user mobile terminal and identification information of the relay device, and records the pieces of information in the time and attendance information storage device so as to be associated with each other.

8. The data processing method of the time and attendance management device described in any one of 1 to 7, in which the time and attendance management device is the user mobile terminal or a server device that can communicate with the user mobile terminal.

9. A program causing a computer for realizing a time and attendance management device to execute:

a procedure for starting an application which uses an imaging function on a user mobile terminal by allowing the user mobile terminal having the imaging function to communicate wirelessly with a relay device provided in a place where a user attends and leaves;

a procedure for imaging a face of the user using the imaging function by way of the started application;

a procedure for acquiring face image data of the user recognized from a captured image;

a procedure for extracting feature point data from the face image data of the user; and

a procedure for recording clock-in or clock-out information of the user based on the feature point data, as time and attendance information, in a time and attendance information storage device together with a current time when a clock-in or clock-out of the user is received.

10. The program described in 9, in which the time and attendance information storage device stores scheduled attendance and leaving time of the user and identification information of the relay device provided in the place where the user attends and leaves so as to be associated with identification information of the user mobile terminal, and the program further causes the computer to execute:

a procedure for monitoring whether or not the current time is a time to prompt the user to perform a clock-in or clock-out operation based on the scheduled attendance and leaving time of the user with reference to the time and attendance information storage device; and

a procedure for transmitting notification prompting the clock-in or clock-out operation to the user mobile terminal through the relay device provided in the place where the user attends and leaves when the current time is the time to prompt the user to perform the clock-in or clock-out operation.

11. The program described in 9 or 10, in which the time and attendance information storage device stores scheduled attendance and leaving time of the user and identification information of the relay device provided in the place where the user attends and leaves so as to be associated with identification information of the user mobile terminal, the program further causing the computer to execute:

a procedure for monitoring whether or not clock-out information of the user has been recorded in the time and attendance information storage device after a predetermined time has passed from leaving time of the user based on the scheduled attendance and leaving time of the user with reference to the time and attendance information storage device;

a procedure for making the relay device provided in the place where the user attends and leaves check presence of the user mobile terminal when the clock-out information of the user has not been recorded in the time and attendance information storage device; and

a procedure for recording a current time in the time and attendance information storage device as clock-out information of the user mobile terminal when a result of the presence checking indicates that the user mobile terminal is not present.

12. The program described in 11, further causing the computer to execute a procedure for transmitting notification prompting a clock-in or clock-out operation to the user mobile terminal through the relay device provided in the place where the user attends and leaves when the time and attendance management device confirms that the user mobile terminal is present.

13. The program described in any one of 9 to 12, in which the time and attendance information storage device stores scheduled attendance and leaving time of the user and identification information of the relay device provided in the place where the user attends and leaves so as to be associated with identification information of the user mobile terminal, and

the program further causing the computer to execute a procedure for transmitting alarm notification prompting the user to attend work to the user mobile terminal through the relay device, which is provided in the place where the user attends and leaves, at a predetermined time before the scheduled attendance time based on the scheduled attendance and leaving time of the user with reference to the time and attendance information storage device.

14. The program described in any one of 9 to 13, further causing the computer to execute a procedure for transmitting notification prompting a punching operation for presence checking to the user mobile terminal through the relay device at an arbitrary timing within a period of time, during which the user is to be in the place where the user attends and leaves, based on the time and attendance information of the user with reference to the time and attendance information storage device.

15. The program described in any one of 9 to 14, further causing the computer to execute

a procedure for starting the application on the user mobile terminal when the user mobile terminal present in a wireless communication area of the relay device communicates wirelessly with the relay device, and

a procedure for acquiring identification information of the user mobile terminal and identification information of the relay device and recording the pieces of information in the time and attendance information storage device so as to be associated with each other.

16. The program described in any one of 9 to 15, in which the time and attendance management device is the user mobile terminal or a server device that can communicate with the user mobile terminal.

This application is based upon and claims the benefit of priority from Japanese Patent Application No. 2012-164126 filed on Jul. 24, 2012, the disclosure of which is incorporated herein in its entirety by reference.

What is claimed is:

1. A time and attendance management device, comprising:
a control unit that starts an application which uses an imaging function on a user mobile terminal by allowing the user mobile terminal having the imaging function to communicate wirelessly with a relay device provided in a place where a user attends and leaves;
an imaging unit that images a face of the user using the imaging function byway of the application started by the control unit;
an extraction unit that acquires face image data of the user recognized from a captured image and extracts feature point data from the face image data of the user; and
a recording unit that records dock-in or dock-out information of the user based on the feature point data, as time and attendance information, in a time and attendance information storage device together with a current time.

2. The time and attendance management device according to claim 1,
wherein the time and attendance information storage device stores scheduled attendance and leaving time of the user and identification information of the relay device provided in the place where the user attends and leaves so as to be associated with identification information of the user mobile terminal,
the time and attendance management device further comprising:
a monitoring unit that monitors whether or not the current time is a time to prompt the user to perform a clock-in or clock-out operation based on the scheduled attendance and leaving time of the user with reference to the time and attendance information storage device; and
a clock-in and clock-out notification unit that transmits notification prompting the clock-in or clock-out operation to the user mobile terminal through the relay device provided in the place where the user attends and leaves when the current time is the time to prompt the user to perform the clock-in or clock-out operation.

3. The time and attendance management device according to claim 1,
wherein the time and attendance information storage device stores scheduled attendance and leaving time of the user and identification information of the relay device provided in the place where the user attends and leaves so as to be associated with identification information of the user mobile terminal,
the time and attendance management device further comprising:
a clock-out monitoring unit that monitors whether or not clock-out information of the user has been recorded in the time and attendance information storage device after a predetermined time has passed from leaving time of the user based on the scheduled attendance and leaving time of the user with reference to the time and attendance information storage device; and
a checking unit that makes the relay device provided in the place where the user attends and leaves check presence of the user mobile terminal when the clock-out information of the user has not been recorded in the time and attendance information storage device, and
wherein, when a result of the presence checking indicates that the user mobile terminal is not present, the recording unit records a current time in the time and attendance information storage device as clock-out information of the user mobile terminal.

4. The time and attendance management device according to claim 3,
wherein, when the checking unit confirms that the user mobile terminal is present, the clock-in or clock-out notification unit transmits notification prompting a clock-in or clock-out operation to the user mobile terminal through the relay device provided in the place where the user attends and leaves.

5. The time and attendance management device according to claim 1,
wherein the time and attendance information storage device stores scheduled attendance and leaving time of the user and identification information of the relay device provided in the place where the user attends and leaves so as to be associated with identification information of the user mobile terminal, and
the time and attendance management device further comprising:
a notification unit that transmits alarm notification prompting the user to attend work to the user mobile terminal through the relay device, which is provided in the place where the user attends and leaves, at a predetermined time before the scheduled attendance and leaving time based on the scheduled attendance and leaving time of the user with reference to the time and attendance information storage device.

6. The time and attendance management device according to claim 1, further comprising:
a presence checking unit that transmits notification prompting a punching operation for presence checking to the user mobile terminal through the relay device at an arbitrary timing within a period of time, during which the user is to be in the place where the user attends and leaves, based on the time and attendance information of the user with reference to the time and attendance information storage device.

7. The time and attendance management device according to claim 1,
wherein, when the user mobile terminal present in a wireless communication area of the relay device communicates wirelessly with the relay device, the control unit starts the application on the user mobile terminal, and
the recording unit acquires identification information of the user mobile terminal and identification information of the relay device and records the pieces of information in the time and attendance information storage device so as to be associated with each other.

8. The time and attendance management device according to claim 1,
wherein the time and attendance management device is the user mobile terminal or a server device that can communicate with the user mobile terminal.

9. A data processing method of a time and attendance management device, comprising:
starting, by the time and attendance management device, the an application which uses an imaging function on a user mobile terminal by allowing the user mobile terminal having the imaging function to communicate wirelessly with a relay device provided in a place where a user attends and leaves;
imaging, by the time and attendance management device, a face of the user using the imaging function by way of the started application;
acquiring, by the time and attendance management device, face image data of the user recognized from a captured image;
extracting, by the time and attendance management device, feature point data from the face image data of the user; and
recording, by the time and attendance management device, clock-in or clock-out information of the user based on the feature point data, as time and attendance information, in a time and attendance information storage device together with a current time.

10. (canceled)

11. A computer program product comprising a computer readable medium storing instructions adapted to enable a hardware processor of a computer to implement a time and attendance management system by performing steps comprising:
starting an application which uses an imaging function on a user mobile terminal by allowing the user mobile terminal having the imaging function to communicate wirelessly with a relay device provided in a place where a user attends and leaves;
imaging a face of the user using the imaging function by way of the started application;
acquiring face image data of the user recognized from a captured image;
extracting feature point data from the face image data of the user; and
recording clock-in or clock-out information of the user based on the feature point data, as time and attendance information, in a time and attendance information storage device together with a current time when a clock-in or clock-out operation of the user is received.
